(19) United States
(12) Patent Application Publication
(10) Pub. No.: US 2008/0003335 A1
(43) Pub. Date: Jan. 3, 2008

(54) Egg product and production method

(76) Inventors: Prem S. Singh, Glen Ellyn, IL (US); Albert D. Bolles, Lake Forest, IL (US); Robert W. Hill, Omaha, NE (US); Deijing Fu, Lisle, IL (US); James Costelloe, Naperville, IL (US); Thomas Henry, McHenry, IL (US)

Correspondence Address: SUITER SWANTZ PC LLO, 14301 FNB PARKWAY, SUITE 220, OMAHA, NE, 68154, US

(21) Appl. No.: 11/811,904

(22) Filed: Jun. 12, 2007

Related U.S. Application Data
(60) Provisional application No. 60/812,880, filed on Jun. 12, 2006.

(51) Int. Cl. A23B 5/00; A23B 5/02; A23B 5/025; A23B 5/035; B05B 3/14

(52) U.S. Cl. 426/299; 426/298; 426/300; 426/614; 99/483; 99/484; 99/486; 99/516

(57) ABSTRACT

A reduced egg product produced by supercritical fluid extraction comprising egg yolk from a whole egg that has a portion of undesired components, such as cholesterol and triglycerides (including saturated fats), selectively removed from the natural egg yolk while the beneficial components, such as phosphotipids, are selectively retained and while the consumer-desired flavor, texture, and/or functionality of the egg yolk is retained. A method for producing the reduced egg product comprises at least one of separating, drying, and extracting and optionally reconstituting. The continuous drying method produces dried egg yolk with a honeycomb type structure or small particle with low densities allowing for effective extraction and reconstitution. Furthermore, the reconstituting method is efficient and the pasteurizing method is capable of pasteurizing triglyceride and fat reduced egg yolk and triglyceride and fat reduced whole egg.

### CROSS-REFERENCE TO RELATED APPLICATIONS

The present application claims the benefit under 35 U.S.C. §·119(e) of U.S. Provisional Application Ser. No. 60/812,880, filed Jun. 12, 2006. Said U.S. Provisional Application Ser. No. 60/812,880 is herein incorporated by reference in its entirety.

### FIELD OF THE INVENTION

The present invention generally relates to the field of food products, and more particularly to an egg product (and egg product processes), such as a liquid egg product, with reduced cholesterol and/or reduced triglycerides (including saturated fats) without altered functionality and flavor and/or reduced phospholipids.

### BACKGROUND OF THE INVENTION

Whole eggs are commonly prepared by scrambling and frying for a main or side dish in meals. The term “whole egg” refers to the natural proportion of egg white and egg yolk typically found in naturally shelled eggs, including any additives commonly utilized in the art. Eggs are also included in combination with other various ingredients for production of baked goods or other foodstuffs. For example, eggs are utilized in cakes, cookies, ice cream, omelets, and other products. Additionally, uncooked eggs may be utilized in other applications such as mayonnaise and egg nog.

Egg yolk makes up about 33% to 35% of the liquid weight of an egg. It contains most to all of the fat and slightly less than half of the protein in the egg. With the exception of riboflavin and niacin, the egg yolk contains a higher proportion of the egg's vitamins than the egg white. The egg yolk also contains more phosphorus, manganese, iron, iodine, copper, and calcium than the egg white, and it contains all of the zinc. Additionally, the egg yolk contains lecithin and cephalin, phospholipids that provide emulsifying properties, which are useful in recipes requiring a mixture of oil-based and water-based ingredients, such as in mayonnaise. Phospholipids also constitute cell membranes and aid in the metabolism of fats. Thus, phospholipids, such as lecithin, are generally beneficial components of whole eggs, and particularly the egg yolk.

The egg white, or albumen, accounts for about 65% to 67% of the liquid weight of an egg. The egg white contains more than half the egg's total protein, niacin, riboflavin, chlorine, magnesium, potassium, sodium and sulfur. When the egg white is subjected to shear stresses, such as vigorous beating, the egg white increases in volume to form egg foam. For instance, this foam may be utilized in foodstuff applications such as souffles, meringue, angel food cake, sponge cakes, and aerosol-based creams.

While the flavor and functionality of whole eggs are desirable, the egg yolk includes undesirable lipids. Typically, lipids can be divided into two generalized types, one of which is undesirable. For example the two generalized types of lipids comprise polar and non-polar lipids. The non-polar lipids include cholesterol and triglycerides (including saturated fats), which are the undesirable lipids. When cholesterol levels are too high, the LDL, a carrier of cholesterol, tends to stick to the lining of the blood vessels. The adhered LDL increases the rigidity of the arteries, known as atherosclerosis. The buildup of substances on the arterial walls (known as plaque) can lead to increased risk of heart attack and stroke. Thus, an elevated LDL cholesterol level is a factor for cardiac disease. Similarly, high triglyceride levels have been associated with increased risk factors for cardiac disease; however, it is unclear if triglycerides are an independent risk factor. Patients with elevated triglyceride levels almost invariably have other major risk factors for heart disease (typically obesity, diabetes, and/or high blood pressure), and thus it is difficult to determine whether the triglycerides themselves pose an independent risk. Regardless of independence, high levels of triglycerides are generally accepted as undesirable. Further, consumption of large amounts of food products high in triglycerides and cholesterol are deemed likely contributors to cardiac problems associated with higher LDL and triglyceride levels in the bloodstream.

Previous process systems, including extraction systems exist that reduce triglycerides and/or cholesterol in egg yolk. These systems often comprise a dryer and an extractor. However, these previous systems do not produce an egg product with consumer-desired flavor, texture, and functionality. Moreover, many of the previous systems do not allow a substantial amount of the beneficial phospholipids to be retained by selectively not extracting the phospholipids during the extraction of the triglycerides and cholesterol from the egg yolk, while still retaining functionality, flavor, and texture in the egg yolk. Additionally, the drying processes of previous methods are not conducive to a high production flow rate, are not really efficient, and do not enable highly efficient extraction and further reconstitution. Furthermore, the prior methods do not pasteurize whole egg with reduced cholesterol and reduced triglycerides and are not as efficient, as effective, or as continuous.

Therefore, it would be desirable to provide a suitable egg product with reduced cholesterol and/or reduced triglycerides (including saturated fats), which retains desirable lipids, functionality, flavor, and texture to overcome the shortcomings of the previous produced egg products and systems for making such egg products. Further, it would be desirable to provide a more efficient and protein stable (e.g., protein that is not substantially denatured) drying process, extraction process, and reconstitution process to overcome the shortcomings of the previously produced reduced cholesterol and triglycerides egg products and systems for making such egg products. Moreover, it would be desirable to provide a pasteurizing system for pasteurizing cholesterol and triglyceride reduced egg yolk, as well as reduced whole egg.

### SUMMARY OF THE INVENTION

Accordingly, the present invention is directed to an egg product, such as a liquid egg product, that retains the consumer-desired functionality, flavor, and texture of a whole egg, while lacking the undesirable components, such as cholesterol and triglycerides (including saturated fats), and maintaining the desired phospholipids and the method of making such a product. The present invention is also directed to a system for producing the reduced cholesterol and/or triglyceride egg product. The system may comprise at least one of a separator, dryer, extractor, reconstitutor, pasteurizer, or aseptic filler. The egg product of the present invention may retain substantially all the natural egg yolk and egg white components, thus providing the consumer with a whole egg eating experience.

In one aspect of the invention, the egg product produced from the method of the present invention substantially retains functionality, flavor, and texture.

In another aspect of the invention, the drying process results in a continuous drying process, in more efficient and protein stable (e.g., protein that is not substantially denatured) extraction of cholesterol and/or triglycerides, in more efficient reconstitution of the dried egg yolk, and in less oxidation than previously utilized drying processes for triglyceride and/or cholesterol extraction from egg yolk.

In a further aspect of the invention, the reconstituting system is more efficient than previous methods utilized to reconstitute dried egg yolk.

In another aspect of the invention, a pasteurizing process is capable of pasteurizing cholesterol and/or triglyceride reduced egg yolk and/or cholesterol and/or triglyceride reduced whole egg.

It is to be understood that both the foregoing general description and the following detailed description are exemplary and explanatory only and are not necessarily restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a flow diagram illustrating a system for producing a reduced egg product, in accordance with an exemplary embodiment of the present invention;

FIG. 2 is a partial flow diagram of the system illustrated in FIG. 1, FIG. 3, and FIG. 5 further illustrating the reconstitutor;

FIG. 3 is a flow diagram illustrating a system for producing a reduced egg product in accordance with another exemplary embodiment of the present invention;

FIG. 4 is a partial flow diagram of the system illustrated in FIG. 5 further illustrating the pasteurizer;

FIG. 5 is a flow diagram illustrating a system for product finishing, in accordance with an exemplary embodiment of the present invention;

FIGS. 6A and 6B are a partial flow diagram of the system illustrated in FIG. 2 further illustrating the high shear mixer 116 and FIG. 9 further illustrating the mixer/reconstitutor 236;

FIG. 7 is a flow diagram illustrating a method for producing a reduced is egg product, the reduced egg product comprising a portion of egg yolk obtained from whole egg, in accordance with an exemplary embodiment of the present invention;

FIG. 8 is a flow diagram illustrating a method for producing a food product made from a reduced egg product, the reduced egg product comprising a portion of egg yolk obtained from whole egg, in accordance with an exemplary embodiment of the present invention;

FIGS. 9A and 9B are flow diagrams illustrating a system for producing a reduced egg product, in accordance with an exemplary embodiment of the present invention;

FIG. 10 is a diagram illustrating the various percentages of components throughout the steps of systems 100 and 200 in an exemplary embodiment of the present invention;

FIG. 11 is a flow diagram illustrating a method for producing a dried egg yolk with a honeycomb type structure, in accordance with an exemplary embodiment of the present invention;

FIG. 12 is a flow diagram illustrating a method for producing a dried egg yolk with an average diameter of about 30 microns to about 2200 microns, in accordance with an exemplary embodiment of the present invention;

FIG. 13 is a flow diagram illustrating a method for reconstituting dried egg yolk, in accordance with an exemplary embodiment of the present invention;

FIG. 14 is a graph illustrating a comparison of different supercritical CO₂ fluid extraction efficiencies, in accordance with an exemplary embodiment of the present invention;

FIG. 15 is a graph illustrating a comparison of different supercritical is CO₂ fluid extraction efficiencies for three dried egg yolk samples extracted at different temperatures, in accordance with an exemplary embodiment of the present invention;

FIG. 16 is a graph illustrating a comparison of extracted oil percentage in relation to overall extraction time for the same three dried egg yolk samples extracted at varying temperatures utilized in FIG. 15, in accordance with an exemplary embodiment of the present invention; and

FIG. 17 is a graph illustrating a comparison of different supercritical CO₂ fluid extraction efficiencies for an extractor with one column verses two columns, in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

The present invention is directed to a reduced egg product comprising an egg yolk with a substantially reduced amount of cholesterol and/or triglycerides, without a reduced amount of phospholipids, and with egg yolk protein structures that have not been substantially denatured to prevent a substantial loss of functionality and/or a substantial change in flavor and texture. Further, the present invention is directed to a system and method of producing the reduced egg product. As used herein, the phrases “retaining phospholipids” or “without a reduced amount of phospholipids” comprises extracting about 0% to about 5% of the phospholipids from the egg yolk. The reduced egg product may be in a dried or liquid form. In one embodiment, the reduced egg product may comprise liquid and/or dry egg white product, such as a liquid egg product. For instance, an egg white product comprises natural egg white and/or simulated egg white. As used herein, the reduced egg product comprises an egg yolk with reduced cholesterol and/or reduced triglycerides, without a reduced amount of phospholipids, such as lecithin, and without detrimentally changing the structure of egg yolk proteins to prevent a substantial loss of functionality and/or a substantial change in flavor and texture.

In one embodiment, a substantially reduced amount of triglycerides is achieved when from about 84% to about 100% of the total amount of triglycerides have been extracted from the egg yolk of the reduced egg product. In another embodiment, a substantially reduced amount of cholesterol is achieved when from about 84% to about 98% of the total amount of cholesterol has been extracted from the egg yolk of the reduced egg product. The term “triglycerides” refers to fats and oils and comprises saturated fats, monounsaturated fats, polyunsaturated fats, trans-fatty acids, and essential fatty acids. As used herein, the term “extracted oil” refers to the cholesterol and triglycerides (including saturated fats) that have been extracted from the dried egg yolk by the supercritical fluid extractor of the present invention.

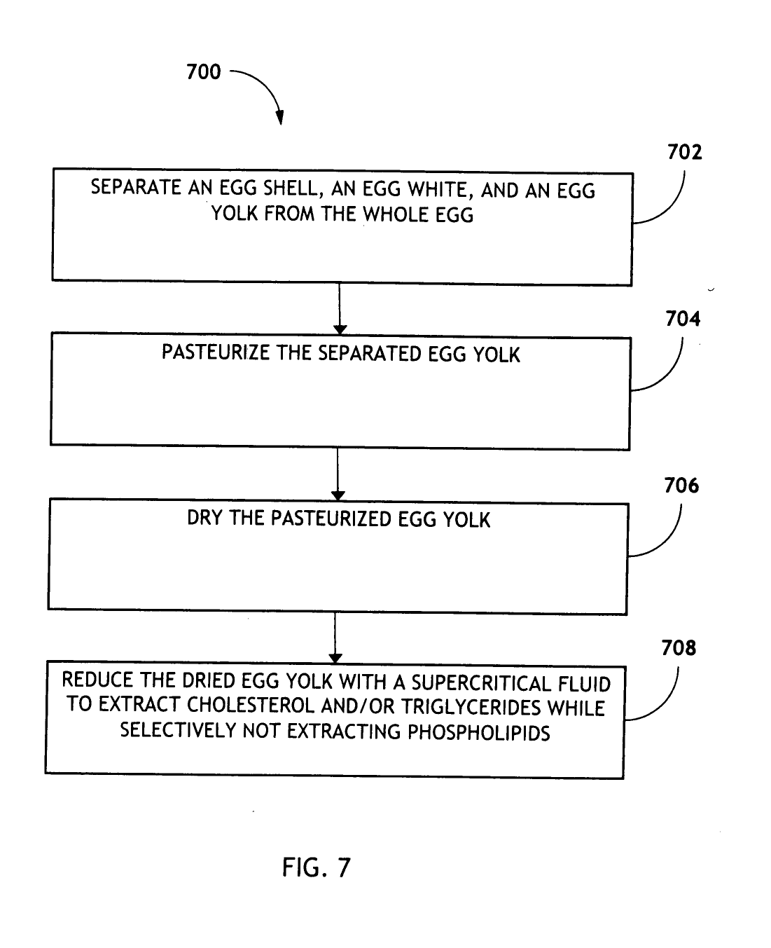

Referring to FIG. 7 a method 700 for producing a reduced egg product, the reduced egg product comprising a portion of egg yolk obtained from whole egg is shown in accordance with the exemplary embodiments of the present invention. Method 700 separates an egg shell, an egg white, and an egg yolk from the whole egg 702. Method 700 pasteurizes the separated egg yolk 704. Method 700 dries the pasteurized egg yolk 706. Method 700 reduces the dried egg yolk with a supercritical fluid to extract cholesterol and/or triglycerides while selectively not extracting phospholipids 708.

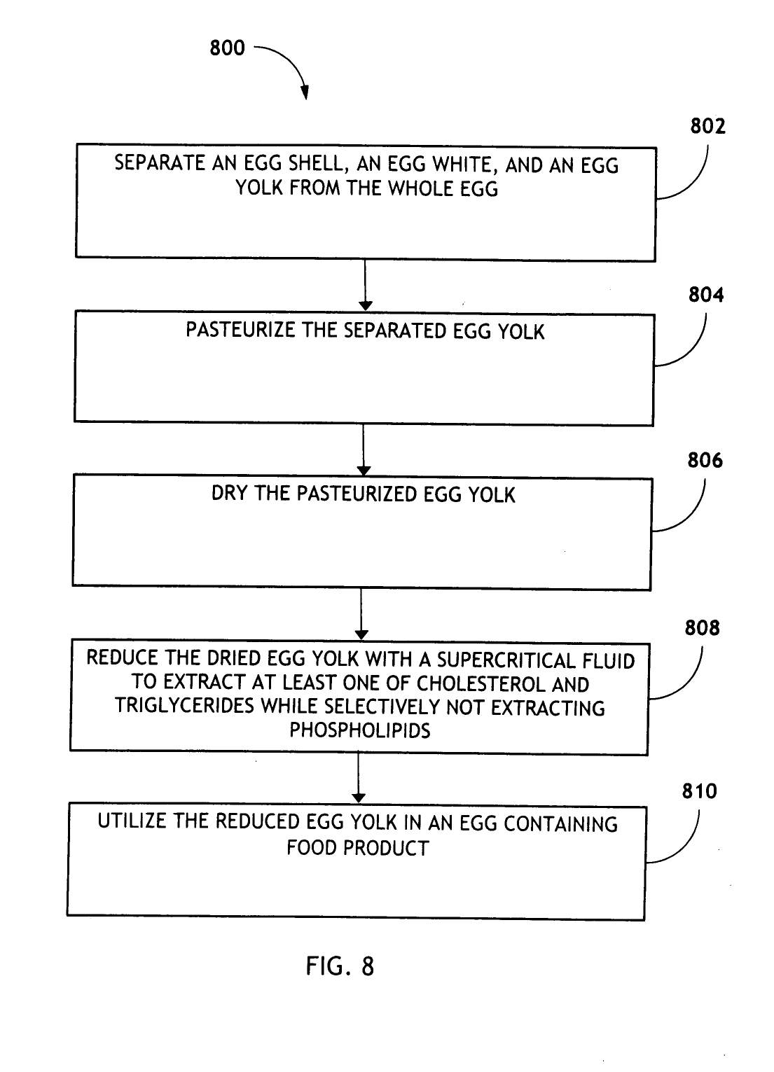

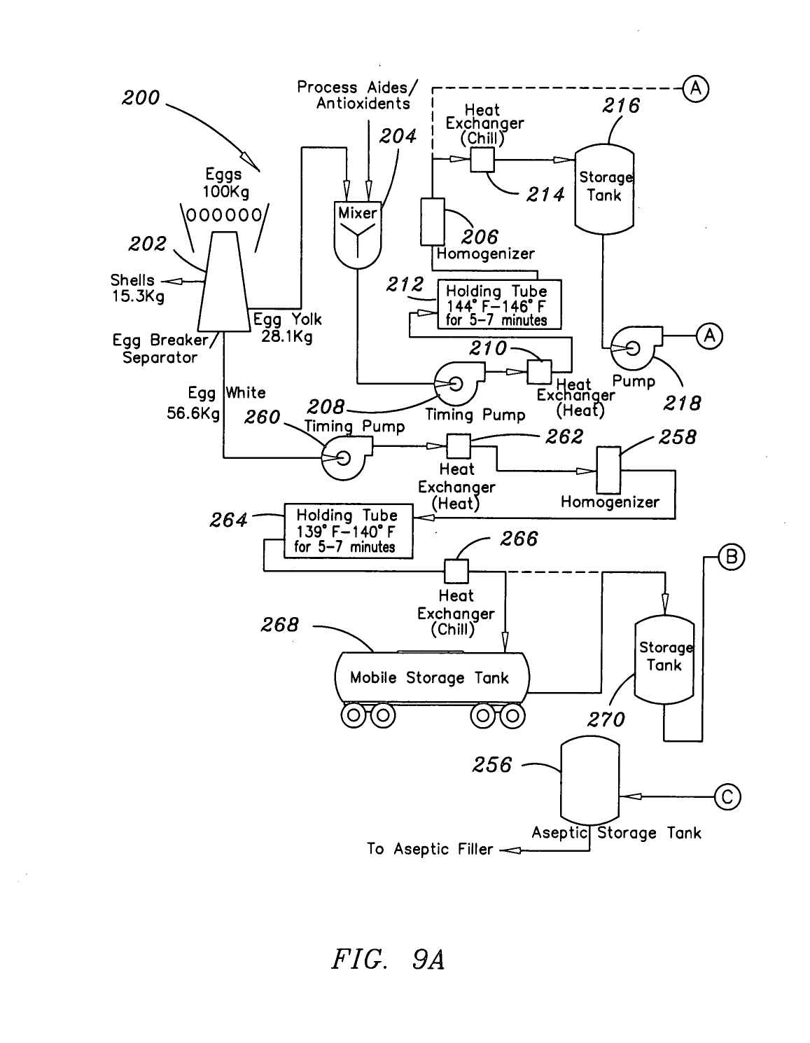

Referring to FIG. 8 a method 800 for producing a food product made from a reduced egg product is shown in accordance with the exemplary embodiments of the present invention. Method 800 separates an egg shell, an egg white, and an egg yolk from the whole egg 802. Method 800 pasteurizes the separated egg yolk 804. Method 800 dries the pasteurized egg yolk 806. Method 800 reduces the dried egg yolk with a supercritical fluid to extract cholesterol and/or triglycerides while selectively not extracting phospholipids 808. Method 800 utilizes the reduced egg yolk in an egg containing food product 810. For example, an egg containing food product may comprise, omelets, mayonnaise, egg nog, liquid egg products, ice cream, baked goods, custards, souffles, meringue, angel food cake, sponge cakes, and aerosol-based creams.

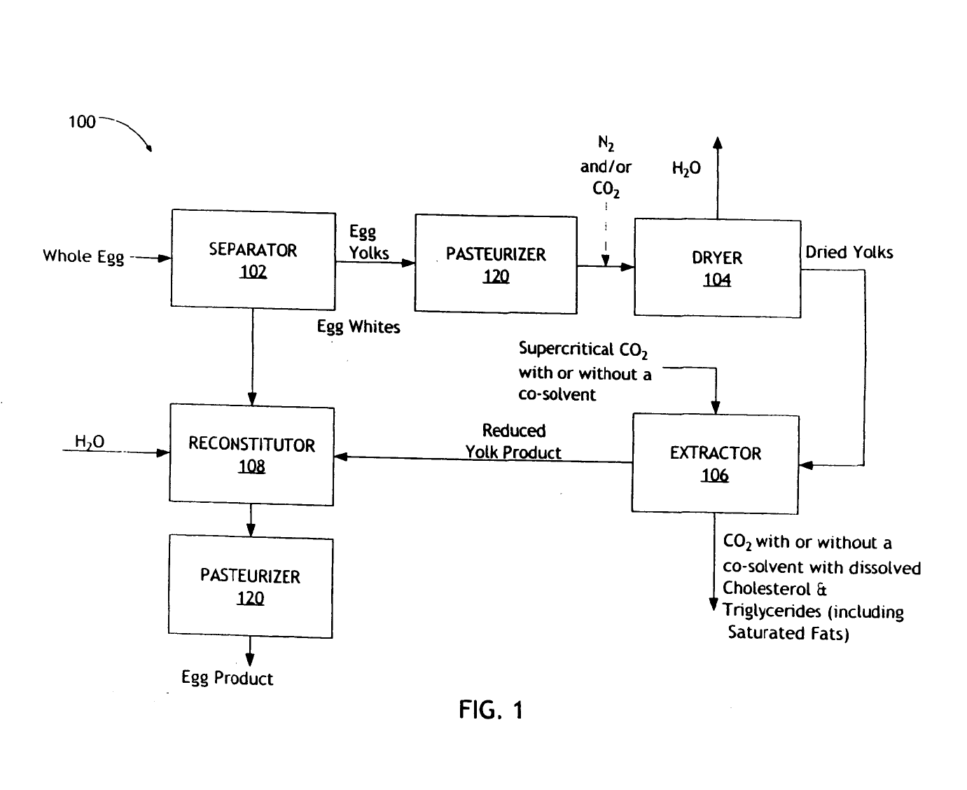

Referring generally to FIGS. 1, 3, 5, 7, and 9, a system 100 and 200 for producing a reduced egg product as previously described is shown in accordance with the exemplary embodiments of the present invention. System 100 and 200 of the present invention comprise at least one of a:
I. Separator;
II. Pasteurizer;
III. Dryer including a
   A. Belt Dryer, or
   B. Spray Dryer; and
IV. Extractor.
   In one embodiment, the system 100 and 200 may further comprise at least one of a:
V. Reconstitutor, or
VI. Product Finishing including a
   A. Pasteurizer, or
   B. Packager.

The products of system 100 and 200 may retain substantially all the natural egg yolk and egg white components, thus providing the consumer with a whole egg eating experience. In exemplary embodiments, the dryer of system 100 and 200 allows for a more continuous flow than dryers utilized in previous methods, enables more efficient and protein stable (e.g., protein that is not substantially denatured) extraction and reconstitution than previous dryers allowed, and/or prevents oxidation better than previous dryers. In another embodiment, the reconstitutor of system 100 and 200 reconstitutes more efficiently than previously utilized reconstitutors. In a further embodiment, the pasteurizer of system 100 and 200 effectively pasteurizes reduced cholesterol and/or reduced triglyceride egg yolk and reduced cholesterol and/or reduced triglyceride whole egg.

The separating, pasteurizing, drying, extracting, reconstituting, and product finishing steps of system 100 and/or 200 may each operate on a continuous, batch, mixed batch, or other basis to ensure method efficiency and product quality. The resultant reduced egg product of system 100 and/or 200 may be utilized in multiple applications. For example, the reduced egg product may be utilized in an egg containing product, such as For example, an egg containing food product may comprise, omelets, mayonnaise, egg nog, liquid egg products, ice cream, baked goods, custards, souffles, meringue, angel food cake, sponge cakes, and aerosol-based creams.

Referring to FIGS. 1, 3, 5, and 7, a system 100 for producing a reduced egg product is shown in accordance with the exemplary embodiments of the present invention. In one embodiment, the product of system 100 in FIGS. 1, 3, 5, and 7 is a reduced egg product of the present invention as previously described, comprising natural egg white and egg yolk components, along with other potential components. For example, the natural egg yolk and the natural egg white are derived from the natural shelling of a whole egg and include any additives commonly utilized in the art. For example, a whole egg refers to the natural proportion of egg white and egg yolk typically found in naturally shelled eggs, including any additives commonly utilized in the art.

Referring to the exemplary embodiments of FIGS. 1, 3, 5, and 7 of the present invention, the feed into the system may comprise egg whites and egg yolks obtained from breaking or shelling whole eggs, 100. A whole egg comprises protein, nutrients, and lipids. For example, nutrients are vitamins and minerals and any other healthy compound found in the whole egg that is not classified as a lipid or protein. An exemplary nutrient, protein, and lipid composition of a whole large egg (e.g., 24 ounce minimum net weight per dozen eggs) may be approximated by the following table:

| | | | |
|---|---|---|---|
| NUTRIENT AND UNIT | WHOLE | WHITE | YOLK |

Proximate

| | | | |
|---|---|---|---|
| Water--g. | 37.66 | 29.33 | 8.1 |
| Food energy-- | 75 | 17 | 59 |
| calories. | | | |
| Protein (N × | 6.25 | 3.52 | 2.78 |
| 6.25)--g. | | | |
| Total lipid--g. | 5.01 | — | 5.12 |
| Total | 0.61 | 0.34 | 0.3 |
| carbohydrate--g. | | | |
| Ash--g. | 0.47 | 0.21 | 0.29 |

Lipids

| | | | |
|---|---|---|---|
| Fatty acids as | 4.327 | — | 4.428 |
| triglycerides--g. | | | |
| Saturated--total g. | 1.55 | — | 1.586 |
| 8:0 Caprylic--g. | 0.002 | — | 0.002 |
| 10:0 Capric--g. | 0.002 | — | 0.002 |
| 12:0 Lauric--g. | 0.002 | — | 0.002 |
| 14:0 Myristic--g. | 0.017 | — | 0.017 |
| 16:0 Palmitic--g. | 1.113 | — | 1.139 |
| 18:0 Stearic--g. | 0.392 | — | 0.401 |
| 20:0 Arachidic**--g. | 0.02 | — | 0.02 |
| Monounsaturate-- | 1.905 | — | 1.949 |
| total g. | | | |
| 14:1 | 0.005 | — | 0.005 |
| Myristoleic**--g. | | | |
| 16:1 Palmitoleic--g. | 0.149 | — | 0.152 |
| 18:1 Oleic--g. | 1.736 | — | 1.776 |
| 20:1 Eicosenoic--g. | 0.014 | — | 0.014 |
| 22:1 Erucic--g. | 0.002 | — | 0.002 |
| Polyunsaturate-- | 0.682 | — | 0.698 |
| total g. | | | |
| 18:2 Linoleic--g. | 0.574 | — | 0.587 |
| 18:3 Linolenic--g. | 0.017 | — | 0.017 |
| Arachidonic--g. | 0.071 | — | 0.073 |
| Eicosapentaeonic--g. | 0.002 | — | 0.002 |
| Docosahexaenoic--g. | 0.018 | — | 0.019 |
| Cholesterol--mg. | 213 | — | 213 |
| Lecithin--g.** | 1.15 | — | 1.11 |
| Cephali--g.** | 0.23 | — | 0.219 |

Vitamins

| | | | |
|---|---|---|---|
| A--IU | 317 | — | 323 |
| D--IU** | 24.5 | — | 24.5 |
| E--mg. | 0.7 | — | 0.7 |
| B12--mcg. | 0.5 | 0.07 | 0.52 |
| Biotin--mcg.** | 9.98 | 2.34 | 7.58 |
| Choline--mg.** | 215.06 | 0.42 | 216 |
| Folic Acid | 23 | 1 | 24 |
| (Folacin)--mcg | | | |
| Inositol--mg.** | 5.39 | 1.38 | 3.95 |
| Niacin--mg (B3) | 0.037 | 0.031 | 0.002 |
| Pantothenic acid--mg | 0.627 | 0.04 | 0.632 |
| Pyridoxine (B6)--mg. | 0.07 | 0.001 | 0.065 |
| Riboflavin (B2)--mg. | 0.254 | 0.151 | 0.106 |
| Thiamine (B1)--mg. | 0.031 | 0.002 | 0.028 |

Minerals

| | | | |
|---|---|---|---|
| Calcium--mg. | 25 | 2 | 23 |
| Chlorine**--mg. | 87.1 | 60 | 27.1 |
| Copper--mg. | 0.007 | 0.002 | 0.004 |
| Iodine**--mg. | 0.024 | 0.001 | 0.022 |
| Iron--mg. | 0.72 | 0.01 | 0.59 |
| Magnesium--mg. | 5 | 4 | 1 |
| Manganese--mg. | 0.012 | 0.001 | 0.012 |
| Phosphorus--mg. | 89 | 4 | 81 |
| Potassium--mg. | 60 | 48 | 16 |
| Sodium--mg. | 63 | 55 | 7 |
| Sulfur**--mg. | 82 | 56 | 25 |
| Zinc--mg. | 0.55 | — | 0.52 |

Amino Acids

| | | | |
|---|---|---|---|
| Alanine--g. | 0.348 | 0.203 | 0.143 |
| Arginine--g. | 0.375 | 0.191 | 0.199 |
| Aspartic acid--g. | 0.628 | 0.358 | 0.272 |
| Cystine--g. | 0.145 | 0.091 | 0.05 |
| Glutamic acid--g. | 0.816 | 0.467 | 0.353 |
| Glycine--g. | 0.21 | 0.123 | 0.086 |
| Histidine--g. | 0.148 | 0.079 | 0.072 |
| Isoleucine--g. | 0.341 | 0.199 | 0.141 |
| Leucine--g. | 0.534 | 0.296 | 0.244 |
| Lysine--g. | 0.449 | 0.239 | 0.221 |
| Methionine--g. | 0.195 | 0.121 | 0.069 |
| Phenylalanine--g. | 0.332 | 0.205 | 0.119 |
| Proline--g. | 0.249 | 0.137 | 0.116 |
| Serine--g. | 0.465 | 0.242 | 0.238 |
| Threonine--g. | 0.3 | 0.16 | 0.148 |
| Tryptophan--g. | 0.076 | 0.043 | 0.033 |
| Tyrosine--g. | 0.255 | 0.137 | 0.124 |
| Valine--g. | 0.381 | 0.224 | 0.155 |

*1989 Supplement-Agriculture Handbook No. 8, Human Nutrition Information Service, USDA
**1979 Poultry Science 58: 131-134
Assayed nutrient values for a large raw egg
Based on 59 g. shell weight with 50 g. total liquid whole egg, 33.4 g. white and 16.6 g. yolk

The above table is an approximate composition of an exemplary large chicken egg. However, the present invention is not limited to these approximate egg compositions. For example, various grades (e.g., AA, A, and B) and sizes (e.g., jumbo, extra large, large, medium, etc.) of eggs may result in different compositions. Additionally, eggs from other animal species may have desirable characteristics for utilization in system 100, especially for consumers in international markets. Therefore, it will be appreciated that different grades, sizes, and species of eggs may be utilized without departing from the scope and intent of the present invention.

I. Separator

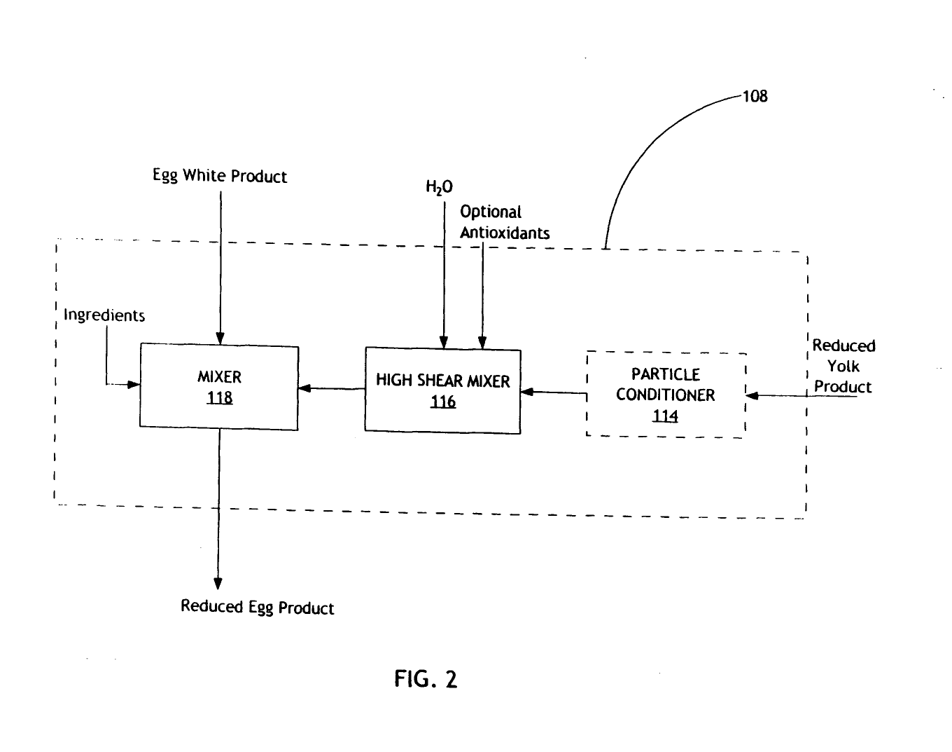

In one embodiment, the shelled whole egg undergoes a separation in separator 102, wherein the egg yolks are substantially separated from the egg whites (FIGS. 1, 3, 5, or 7). For instance, a straining device in separator 102 may remove unbroken egg yolks from an egg white stream, while broken yolks may be removed via density or adhesive differentials. Alternatively, the whole egg cracking method may occur nearly simultaneously with the separation method, such as through the utilization of a suitable egg cracking and separation machine utilized in the art. In another embodiment, a candling system may be utilized to ensure egg yolk IS quality, such that substantially no blood spots, foreign particles, or cracks are included in the egg yolks or on the egg shell. For example, separator 102 may additionally feature an albumen recovery system to maximize production yield of egg whites. For instance, the separator may be of the type disclosed in U.S. Pat. No. 5,628,246 herein incorporated by reference. In a specific embodiment, the products of separator 102 comprise egg yolks, which are further processed, and egg whites, which may be fed into the mixer 118 of a reconstitutor 108 as illustrated in FIG. 2. In one embodiment, the separator 102 may comprise the utilization of human labor to substantially separate egg yolk from egg white.

However, it is also foreseeable that system 100 may obtain egg yolks and/or egg white product as the process feed for bypassing separator 102. In one embodiment, egg white product is utilized in system 100. In another embodiment, egg white product is not utilized in system 100.

II. Pasteurizer

The separated egg yolks may be pasteurized in a pasteurizer 120, to eliminate harmful microorganisms within the egg yolks and to extend the shelf life of the end product, the egg product or the egg containing food product. Pasteurizer 120 may comprise technologies such as heating (single or multi-stage), radiation, chemical, ultrasonic, high pressure pasteurization, some other suitable pasteurizing technique, and/or a combination of pasteurizing techniques. This list is exemplary only. It is contemplated that other suitable microbial killing and/or shelf life extending technologies may be utilized without departing from the scope and intent of the present invention.

Heating pasteurization denatures the proteins of bacteria and other microorganisms to deactivate them. However, if the heat level exceeds the tolerance level of the egg product, then the egg proteins will also denature. Chemical pasteurization may involve altering the pH of the product to kill microorganisms. Ultrasonic pasteurization utilizes sound wave technology to separate a product from the microorganisms and pathogens. High pressure pasteurization (HPP) involves subjecting a substance to high pressures (e.g., 85,000 psi). The high pressure ruptures the cells of microorganisms, resulting in a pasteurized product. The utilization of HPP enables the egg product to be directly subjected to HPP, then aseptically packaged, or packaged first, then subjected to HPP.

Following the egg yolk processing path, after pasteurization, the egg yolks are fed into a dryer 104, 220, and 272, such as a vacuum belt dryer or spray dryer. For example, the dryer 104 (FIGS. 1, 3, 5, 7, and 9) may comprise a dryer with vacuum, temperature, flow rate, distribution pattern, and/or feed temperature control to avoid detrimentally changing the protein structures, which may substantially affect egg functionality, texture, and/or flavor.

Temperature control, such as in the dryer, is critical for system 100 and 200. Temperatures above 65° C. may cause the egg proteins to be denatured, thereby negating the egg yolk functionality. For instance, egg proteins are not substantially denatured if the proteins are still functional and have no consumer noticeable effects on taste, flavor, or texture. Functionality of the egg product can be evaluated with a sponge cake test, by comparing the total sponge cake volume of sponge cake prepared with fresh eggs to a sponge cake prepared with the reduced egg product of the present invention. Furthermore, protein denaturization can be evaluated by utilizing Differential Scanning Calorimetry (DSC) as illustrated in EXAMPLES 4 and 5.

A. Vacuum Belt Dryer

The dryer 104 and 220 (FIGS. 1, 3, 5, 7, and 9) may comprise a vacuum belt dryer with vacuum, temperature, flow rate, distribution pattern, and/or feed temperature control to avoid detrimentally changing the protein structures, which may substantially affect egg functionality, texture, and/or flavor.

In one embodiment, the vacuum belt dryer with vacuum and temperature control 104 sprays egg yolks via a nozzle at a controlled mass flow rate onto a belt placed in a vacuum chamber. Air and water vapor in the vacuum chamber are then pulled out of the chamber by a vacuum pump. For example, the vacuum pressure may be set at 2 mbar to about 10 mbar; however during loading, the vacuum may be set to about 27 mbar. In another specific embodiment, the belt may be about 163 inches long and about 19 inches wide with a belt speed of about 0.75 kg/hr/m² to about 1.1 kg/hr/m².

The egg yolk may be heated through the belt surface by circulated temperature controlled water or oil. The temperature controlled water or oil circulation may be designed to provide a heat gradient, which may vary across the length of the belt. For example, the gradient may range from about 100° C. to about 15° C. in about three to about six different temperature zones across the length of the belt. In one embodiment, the vacuum belt dryer with vacuum and temperature control may have four different temperature zones across its belt. In another embodiment, the vacuum belt dryer with vacuum and temperature control may have five different temperature zones. For example, zone one may be anywhere from about 80° C. to about 90° C., zone two may be anywhere from about 70° C. to about 85° C., zone three may be anywhere from about 60° C. to about 80° C., zone four may be anywhere from about 20° C. to about 60° C., and zone five may be anywhere from about 15° C. to about 35° C.

When the vacuum belt dryer 104 is supplied with liquid egg yolk, its products comprise water and dried egg yolk structures. The moisture content of the dried egg yolk structures may vary, depending on the controlled temperature gradient, belt speed, vacuum conditions, and the like. For example, a controlled moisture range from about 3% to about 5% may be utilized for supercritical extraction. This method of water vaporization creates egg yolk structures with low bulk density. For example, the bulk density may be about 0.146 gm/ml.

In one embodiment, the vacuum belt dryer 104 produces a dried egg yolk with a permeable structure, such as a honeycomb type structure, that allows for a more efficient removal of cholesterol and/or triglycerides Furthermore, the honeycomb type structure allows for a more efficient reconstitution of cholesterol and/or triglyceride reduced dried egg yolk. For example, a honeycomb type structure is generally a discrete and distinct globular structure with numerous pores or holes extending through the structure located proximally to each other. As the egg yolk is heated on the belt, the egg yolk forms a honeycomb type structure because of the gradient heat applied to the thin, substantially even layer of egg yolk and because long protein chains were prevented from forming in the egg yolk by an addition of a processing aid allowing small holes or pores to form in the egg yolk where the water evaporates from the egg yolk during heating.

In one embodiment, the dried egg yolk with a honeycomb type structure may be formed by mixing the liquid egg yolk with one or more processing aids in a mixer before being pumped through the nozzle of the dryer before or after the optional pasteurization of the liquid egg yolk. Processing aids facilitate the drying rate and further reconstitution. For example, processing aids may comprise fiber, sorbitol, maltodextrin, maltodextrose, egg white, starch, and/or other like compounds. It is contemplated that other processing aid may be utilized without departing from the scope and intent of the present invention. In one embodiment, about 2% to about 4% of one or more processing aids is added to the egg yolk by total weight.

In a further embodiment, vitamin C, vitamin E (real or synthetic), rosemary extract, and/or other antioxidants may be added to the liquid egg yolk in a mixer before being pumped through the nozzle of the dryer before or after the pasteurization of the liquid egg yolk to prevent oxidation. In a specific embodiment, about 200 ppm (parts per million) to about 630 ppm of vitamin E is added to the egg yolk. In a further specific embodiment, about 180 ppm to about 330 ppm of vitamin C is added to the egg yolk. The addition of vitamin E, vitamin C, and other antioxidants prevents the fat from oxidizing in the egg yolk.

The processing aids, vitamin E, vitamin C, and other antioxidants may Is be added in varying quantities. When small concentrations of antioxidants and processing aids are added to the liquid egg yolk none of the antioxidants are lost during the drying process showing that the antioxidants did not oxidize and very little or no oxidation took place in the egg yolk. When larger quantities of antioxidants and processing aids are added to the liquid egg yolk, the antioxidants may be slightly lost during the drying process showing that only a small quantity of the added antioxidants were oxidized and only a little oxidation took place in the egg yolk.

In another embodiment, a specific nozzle may be utilized by the vacuum belt dryer to form a dried egg yolk with a honeycomb type structure. In a specific embodiment, the nozzle may oscillate across the belt at a controlled speed and have a head shaped in such a manner to create a substantially even, thin layer of egg yolk that is about 3 mm to about 7 mm thick across the belt. In another specific embodiment, the nozzle may have a temperature of about 20° C. to about 50° C. For instance, typically, the drying rate will be about 0.5 kg/hr/m² to about 1.4 kg/hr/m² (the amount of water removed in a specific time period); however, this rate will vary depending upon the amount of vacuum and degree of belt temperatures utilized.

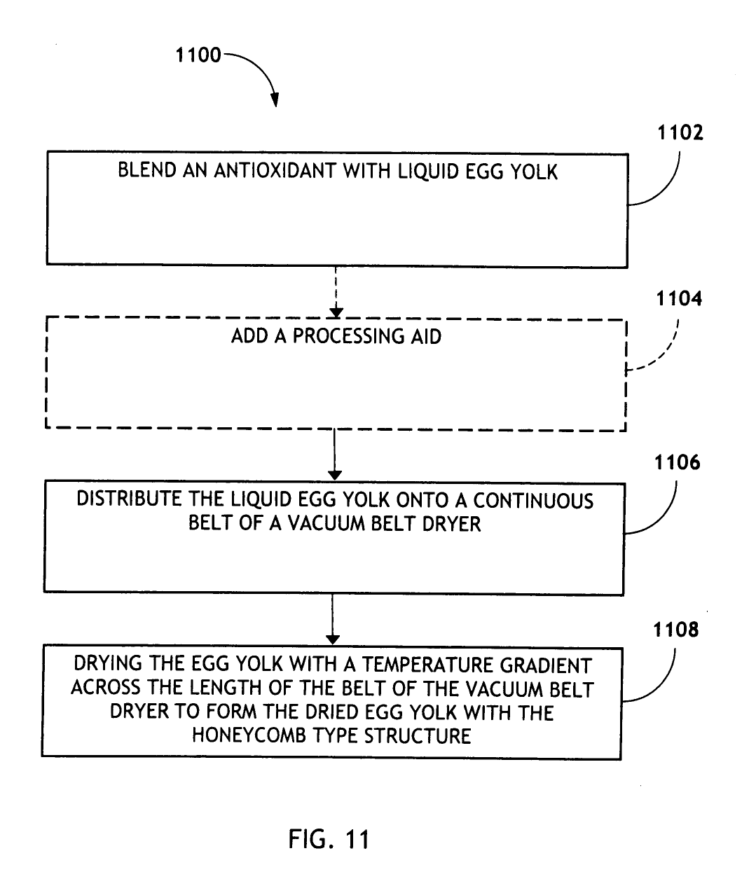

Referring to FIG. 11 a method 1100 of producing a dried egg yolk with a honeycomb type structure is shown in accordance with the exemplary embodiments of the present invention. Method 1100 blends an antioxidant with liquid egg yolk 1102. Method 1100 may optionally add a processing aid to the blended antioxidant and liquid egg yolk 1104. Method 1100 distributes the liquid egg yolk onto a continuous belt of a vacuum belt dryer 1106. Method 1100 dries the egg yolk with a temperature gradient across the length of the belt of the vacuum belt dryer to form the dried egg yolk with the honeycomb type structure 1108.

Previous methods have been implemented that dry egg yolk and allow for cholesterol and triglyceride removal, such as creating porous non-spherical particles of dried egg yolk with small weighted means (e.g., U.S. Pat. No. 5,399,369). For every one pound of dried egg yolk, 100 pounds of CO₂ must be utilized by this previous method to extract cholesterol and/or triglycerides from the dried egg yolk.

However, the belt dryer of the present invention is more efficient than previous methods. The vacuum belt dryer of the present invention allows for a continuous drying process conducive for high production flow rates unlike previous drying methods. Furthermore, the vacuum belt dryer of the present invention creates a more efficient extraction process because of the honeycomb type structure. The pores of the honeycomb type structure allow more solvent (or supercritical fluid) to flow into the dried egg product for a faster extraction rate than previous drying methods allowed. For example, the present invention may only utilize about 80 pounds or less of CO₂ for every one pound of dried egg yolk to extract up to 100% triglycerides and up to 98% cholesterol, which the honeycomb type structure of the dried egg yolk helps facilitate, unlike the previous methods that typically utilize about 100 pounds of CO₂ for every one pound of dried egg yolk. Therefore, the present invention utilizes less CO₂ per pound of solvent while maintaining a high extraction percentage of triglycerides and cholesterol than the previous methods. In a specific embodiment, the present invention may only utilize about 60 pounds or less of CO₂ for every one pound of dried egg yolk to extract up to 100% triglycerides and up to 98% cholesterol, which the honeycomb type structure of the dried egg yolk helps facilitate. Consequently, the vacuum belt drying method of the present invention is less labor intensive, less costly, more effective, and faster for a more efficient overall result than previously utilized drying methods.

The vacuum belt dryer of the present invention also allows for more efficient reconstitution because of the honeycomb type structure. Again the pores of the honeycomb type structure of the dried egg product allow more water to flow into the dried egg product for a faster hydration rate than previous drying methods allow.

B. Spray Dryer

In one embodiment, the dryer 104 and 272 (FIGS. 1, 3, 5, 7, and 9) may comprise a spray dryer with temperature, flow rate, and/or feed temperature control to avoid detrimentally changing the protein structures, which may substantially affect egg functionality, texture, and/or flavor.

In a specific embodiment, antioxidants, such as vitamin E and vitamin C may be added to liquid egg yolk to form a mixture. In another specific embodiment, one or more processing aids may be added to the liquid egg yolk before or after pasteurization. Processing aids facilitate the drying rate and further reconstitution. For example, processing aids may comprise fiber, sorbitol, maltodextrin, maltodextrose, egg white, and starch and/or other like compounds. It is contemplated that other processing aid may be utilized without departing from the scope and intent of the present invention. In one embodiment, about 2% to about 4% of one or more processing aids is added to the egg yolk by total weight.

The mixture may be heated to about 145° F. for about 2.5 minutes to about 5.5 minutes for pasteurization. In one embodiment, N₂ and/or CO₂ gas may be added to the mixture to create bubbles in the mixture causing the egg yolk particles to puff allowing the spray dryer to produce dried egg yolk particles with low densities. The pasteurized mixture may be injected into a spray dryer while still hot. The spray dryer utilizes a heating medium, such as gas, to dry the egg yolk. In one embodiment, the spray dryer may comprise a gravity fall chamber. For instance, the heated mixture may be sprayed at about 90 psi to about 110 psi into a gravity fall in the gravity fall chamber that blows a counter current of the heating medium (e.g., hot air) at about 375° F. to about 425° F. through the falling heated mixture. As defined herein, air is the gas found in a naturally occurring atmosphere around the dryer. In one embodiment, when a spray dryer with a gravity fall chamber is utilized, the heated mixture may fall for about 15 feet to about 25 feet to dry the mixture to form a dried egg yolk. However, it is contemplated that other types of spray dryers may be utilized with present invention without departing form the scope and intent of the present invention.

The evaporated moisture may be excreted with the heating medium. The heating medium will cool as it passes through the dryer and the liquid yolk. In one embodiment, when a gravity fall chamber is utilized the heating medium will exit the dryer at a temperature of about 125° F. to about 195° F. and the dried egg yolk will exit the dryer at about 85° F. to about 135° F. Next, liquid N₂ will be utilized for about 2.5 to about 4.5 minutes to chill the dried egg yolk to a temperature below 85° F. but above 32° F. to prevent oxidation and deter microbiological growth. The resulting dried egg yolk may have globular particles with diameters of about 30 microns to about 200 microns and a bulk density of about 0.45 g/ml to about 0.55 g/ml if N₂ and/or CO₂ are not mixed with the liquid egg product before spray drying. If N₂ and/or CO₂ are mixed with the liquid egg product before spray drying, the resulting dried egg yolk may have globular particles with diameters of about 30 microns to about 2200 microns with a bulk density of about 0.25 g/ml to about 0.4 g/ml. In a specific embodiment, the particle mean particle size is about 1700 micrometers to about 1350 micrometers with a bulk density of about 0.25 g/cm³ to about 0.40 g/cm³.

In one embodiment, N₂ and/or CO₂ may be utilized as the heating medium in the spray dryer instead of air or in combination with the air. In a specific embodiment, the N₂, CO₂, and/or the air and combinations thereof may be recirculated for reutilization in the spray dryer. For example, the exhaust may direct the N₂ into a condenser that extracts the collected moisture from the N₂ and chills the N₂ with cold H₂O. The N₂ is then pumped into a heat exchanger to reheat the N₂ for drying the heated mixture in the spray dryer. The heat exchanger may utilize any suitable technology to heat the N₂, such as streaming N₂ through an inner tube of a tube-within-a-tube, wherein hot oil is pumped through the outer tube to heat the N₂ to about 375° F. to about 425° F.

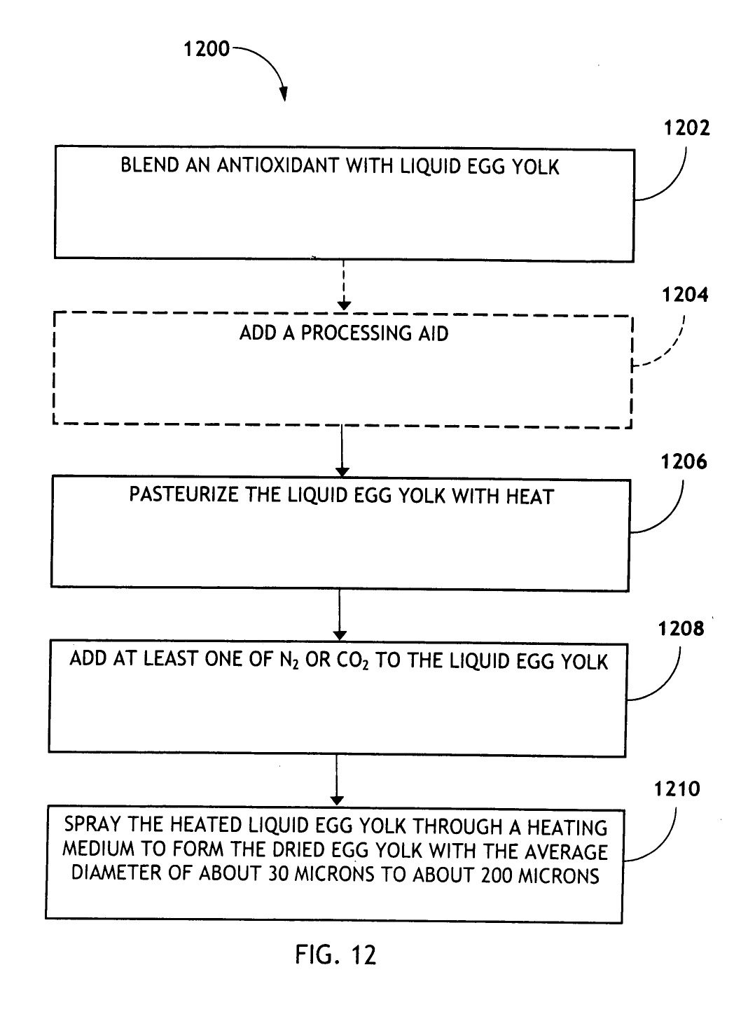

Referring to FIG. 12 a method 1200 of producing a dried egg yolk with an average diameter of about 30 microns to about 2200 microns is shown in accordance with the exemplary embodiments of the present invention. Method 1200 blends an antioxidant with liquid egg yolk 1202. Method 1200 may optionally add a processing aid to the blended antioxidants and liquid egg yolk 1204. Method 1200 pasteurizes the liquid egg yolk with heat 1206. Method 1200 adds N₂ and/or CO₂ to the liquid egg yolk 1208. The antioxidant, the N₂, and/or the CO₂ may be added to the liquid egg yolk before or after the liquid egg yolk is pasteurized. Method 1200 sprays the Is heated liquid egg yolk through a heating medium to form the dried egg yolk with the average diameter of about 30 microns to about 2200 microns 1210. In a specific embodiment, the spray dryer may include a gravity fall chamber. For example, the heating medium may be a heated gas. For instance the heated gas may comprise at least one of air, CO₂, and/or N₂.

Previous patents disclose that spray drying systems are inefficient because the dried egg particles form clumps in the extractor preventing the solvent (supercritical fluid) from flowing through parts of the extractor and leading to non-uniform extraction rates (e.g., U.S. Pat. No. 5,399,369). Spray drying, however, contrary to the teachings of prior art may be utilized effectively with the present invention.

One such previous method, utilizes a vacuum drum dryer to dry the egg yolk for the supercritical fluid extraction of cholesterol and triglycerides. The vacuum drum dryer of this method creates porous non-spherical particles of dried egg yolk with small weighted means (e.g., U.S. Pat. No. 5,399,369). Furthermore, for every one pound of dried egg yolk, 100 pounds of CO₂ must be utilized by this previous method for the extraction of cholesterol and triglycerides from the dried egg yolk (e.g., U.S. Pat. No. 5,399,369, Column 4, Lines 15-21).

The spray dryer of the present invention is more efficient than previous methods because the addition of N₂ and/or CO₂ gas into the liquid egg yolk causes the egg yolk to puff creating a dried egg yolk with a lower bulk density, which prevents the dried egg yolk from clumping in the extractor. Because no clumps are formed in the extractor, the cholesterol and triglycerides are uniformly extracted from the dried egg yolk and the solvent flows unrestricted through the extractor. Furthermore, the present invention does not extract phospholipids and avoids the extra steps of separating the phospholipids out from the extracted cholesterol and triglycerides for reinsertion into the dried egg yolk.

The small particles with low bulk densities produced by the spray dryer of the present invention also help facilitate a lower supercritical fluid ratio. For example, the extractor of the present invention utilizes about 80 pounds or less of CO₂ for every one pound of dried egg yolk to extract up to 100% triglycerides and up to 98% cholesterol. The previous methods typically utilize about 100 pounds of CO₂ for every one pound of dried egg yolk. In a specific embodiment, the extractor of the present invention utilizes about 60 pounds or less of CO₂ for every one pound of dried egg yolk to extract up to 100% triglycerides and up to 98% cholesterol. Therefore, the present invention utilizes less CO₂ per pound of solvent while extracting a high percentage of triglycerides and cholesterol than the previous methods making this method less labor intensive, less costly, more effective, and faster for a more efficient overall result.

Additionally, the spay dryer of the present invention also allows for more efficient reconstitution. The small particles with low bulk densities produced by the spray dryer allow more water to flow through the particles for a faster hydration rate than previous drying methods allow. Moreover, the spray drying method may be more economical than the other drying techniques because the necessary equipment may cost less to operate.

Furthermore, the spray dryer of the present invention produced dried egg yolk with less oxidation. For example, the spray dryer creates particles with high surface areas, but the spray dryer of the present invention utilizes N₂ and/or CO₂ instead of air or in combination with the air to dry the egg yolk to prevent oxidation of the dried egg yolk. Because less of the dried egg yolk is exposed to air in the spray drying method of the present invention, the dried egg yolk of the present invention is less likely to oxidize than the dried egg yolk of previous methods. Also, antioxidants are added to the liquid egg yolk before or after pasteurizing the egg yolk prior to drying helping the egg yolk of the present invention to oxidize less than previously utilized methods.

IV. Extractor

Upon completion of the drying step in dryer 104, 220, or 272 the dried egg yolk passes into the extractor 106 or 224 for supercritical fluid extraction. It is contemplated that suitable high pressure extraction fluids comprise carbon dioxide (CO₂), nitrous oxide, propane, and like solvents and mixtures thereof suitable for extracting cholesterol and/or triglycerides.

The resultant egg yolk structure from the dryer 104, 220, and 272 is prepared for enhanced extraction efficiency in extractor 106 or 224. A supercritical fluid extracts a compound by removing the compound from its original source by absorbing the compound into the supercritical fluid. For preparation, the egg yolk's bulk density is reduced and the egg yolk's surface area is increased to expose more of the egg yolk to the extraction medium. The unique structures of the vacuum belt dried and spray dried egg yolk of the present invention combined with the unique parameters of the supercritical fluid extractor process produces a more efficient extraction by reducing the solvent to dried egg yolk ratio. Additionally, the vacuum belt dryer or the spray dryer prevent the extractor from clogging by Is allowing the supercritical fluid to flow easily through the egg yolk product due to the porous nature of the honeycomb structure formed by vacuum belt drying and the low densities of the small particles formed by the spray dryer. In contrast, typical extractors that utilize different non-permeable structures become clogged with lesser amounts of supercritical fluid pumped through them than the extractor of the present invention creating non-uniform extraction of cholesterol and triglycerides from the dried egg yolk. The clogs need to be cleaned and/or unclogged before reutilization.

In one embodiment, the dried egg yolk is treated with compressed carbon dioxide in the extractor 106. Carbon dioxide has a critical temperature of approximately 31.1° C. At temperatures above the critical temperature, no amount of pressure will change the carbon dioxide phase to a liquid and the phase is termed a supercritical fluid. The critical pressure of carbon dioxide is approximately 73 atm (1073 psi) at the critical temperature of 31.1° C. The critical pressure is the pressure required to liquefy a component at its critical temperature, or the vapor pressure of a material at its critical temperature. Supercritical fluids are neither gases nor liquids, but are best described as an intermediate phase. This phase retains solvent power similar to liquids as well as the transport properties common to gases.

In one embodiment, the present invention may also utilize a co-solvent, such as proponal, ethanol, and other suitable co-solvents with the supercritical fluid for cholesterol and triglyceride extraction. Previous extraction methods often utilized co-solvents with the supercritical fluid to decrease the amount supercritical fluid necessary and for selective triglyceride extraction. However, if co-solvents are utilized the co-solvents have to be separated out from the reduced egg yolk increasing time and labor. In one embodiment, the present invention does not utilize co-solvents; therefore, the present invention may avoid the problems, extra labor, and increased processing time of co-solvents making the present invention more efficient and less costly than methods that utilize co-solvents.

Operating conditions of extractor 106 or 224 may vary, depending on the desired dissolution of cholesterol and triglycerides into the extractor fluid (FIGS. 1, 3, 5, 7 and 9). For example, the temperature may range from about 45° C. to about 75° C. (to prevent egg protein denaturization) and a pressure range from about 300 bar to about 500 bar for extraction with CO₂ supercritical fluid. In one embodiment, the extractor has a temperature of about 65° C. and a pressure of about 500 bar. In another embodiment, the extractor has a temperature of about 50° C. and a pressure of about 341 bar. In a further embodiment, the extractor has a temperature of about 50° C. and a pressure of about 330 bar. In another embodiment, the extractor has a temperature of about 45° C. and a pressure of about 310 bar. In yet another embodiment, the extractor has a temperature of about 60° C. and a pressure of about 310 bar. These conditions maintain carbon dioxide in a supercritical state.

In one embodiment, the extractor may include one column. In another embodiment, the extractor may have multiple columns. An extractor with multiple columns has an increased efficiency as demonstrated in EXAMPLE 12. In a specific embodiment, the multiple column extractor may be arranged with an appropriated valve sequence to permit several modes of operation and semi-continuous extraction. In another specific embodiment, when supercritical CO₂ fluid is utilized, the fluid may be pumped into the different columns sequentially allowing one column to extract, while another column is being loaded and another column is being pressurized. It will be appreciated that the supercritical fluid may be pumped through the different columns of a multiple column extractor in a variety of ways without departing from the scope and intent of the present invention.

Furthermore, in a specific embodiment, the supercritical fluid may be pumped through the column of an extractor from top to bottom or pumped into the side of the extractor closest to the ceiling and then exit from the side of the extractor closest to the floor and/or ground. In another specific embodiment, the supercritical fluid may be pumped through the column of the extractor from bottom to top or pumped into the side of the extractor closest to the floor and/or ground and then exit from the side of the extractor closest to the ceiling. It will be appreciated that the supercritical fluid may be pumped through the column of the extractor in a variety of ways without departing from the scope and intent of the present invention.

In a specific embodiment, the CO₂ may flow through the extractor at a rate of about 5 kg per hour (about 11 lbs/hr) to about 30 kg per hour (about 67 Lbs/hr). Furthermore, the present invention utilizes about 80 pounds of CO₂ or less for every one pound of dried egg yolk to extract at least 84% of cholesterol and/or triglycerides, which are allowed by the honeycomb type structure or the low densities of the small particles of the dried egg yolk and extractor conditions. In one embodiment, the present invention utilizes about 60 pounds of CO₂ or less for every one pound of dried egg yolk to extract at least 84% of cholesterol and/or triglycerides, which are allowed by the honeycomb type structure or the low densities of the small particles of the dried egg yolk and extractor conditions. In another specific embodiment, the extractor may have a diameter of about 104 mm and a height of about 490 mm. Additionally, the operating conditions may be configured to avoid the dissolution of beneficial and healthful components, such as phospholipids, while still maintaining a relatively efficient dissolution of cholesterol and/or triglycerides (including saturated fats).

The reduced egg product of extractor 106 or 224 comprises a yolk product, with a substantially reduced amount of at least one of cholesterol and triglycerides (including saturated fats), while the utilized supercritical fluid of extractor 106 or 224 contains at least one of cholesterol and triglycerides (including saturated fats) dissolved therein. The yolk product then becomes a feed component for a reconstitutor 108 (FIG. 2). In one embodiment, the present invention may extract about 84% to about 100% of the triglycerides comprising saturated fats. In another embodiment, the present invention may extract about 84% to about 98% of cholesterol. In a specific embodiment, the extractor of the present invention may extract about 99.8% triglycerides and about 96.5% cholesterol.

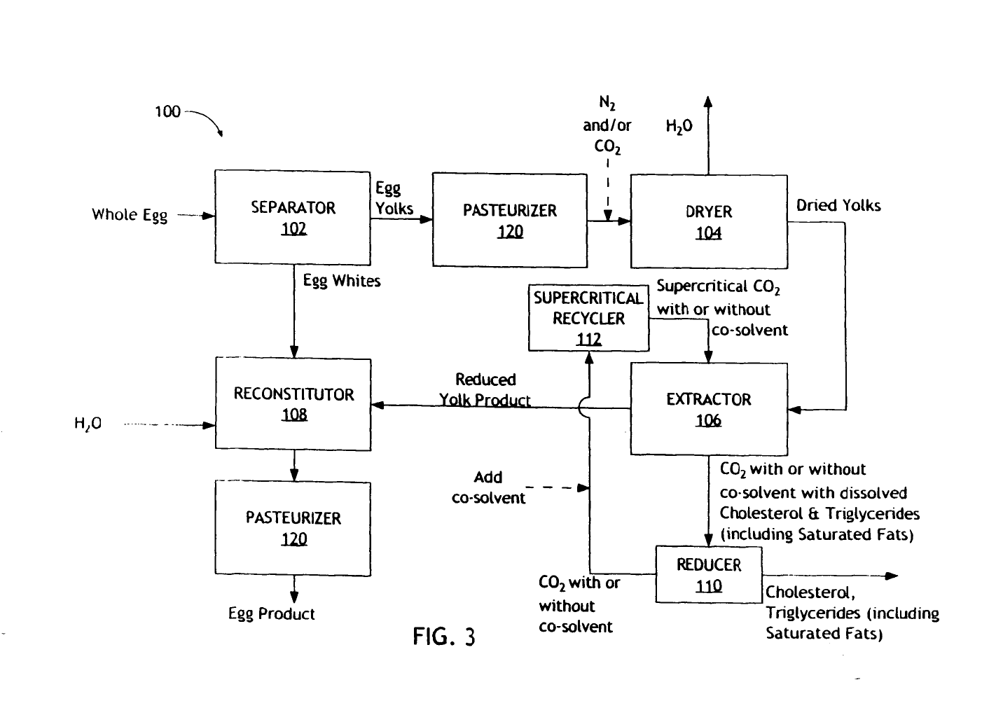

Referring now to the exemplary embodiments of FIG. 3, a supercritical fluid extraction cycle is presented. In one embodiment, the supercritical fluid extraction cycle allows the extraction fluid to be recycled and reutilized in extractor 106. For instance, substances dissolved in supercriticat fluid, such as cholesterol and triglycerides (including saturated fats), may be removed from the fluid stream and the extractor fluid may be prepared for additional extraction in extractor 106. Moreover, the supercritical fluid selectively does not extract phospholipids from the egg yolk. To remove the dissolved substances from the supercritical fluid, reducer 110 may alter the fluid conditions, provide disassociating agents to selectively remove components, or utilize another suitable means for removing the dissolved substances. For example, reducer 110 may reduce the temperature of the supercritical fluid such that the fluid returns to a gaseous phase, thereby significantly reducing the solubility characteristics of the extraction gas. Alternately, reducer 110 could reduce the pressure of the supercriticat fluid to reduce the extraction fluid solubility. In a further embodiment, for carbon dioxide, the former method requires less energy to return the extraction to a supercritical state, due to the relatively tow temperature requirements to achieve the supercriticat state. Thus, temperature reduction may be more feasible. In one embodiment, a separator separate from the reducer may be utilized to separate the triglycerides (including saturated fats) and/or cholesterol from the supercriticat fluid.

In one embodiment, an absorbent, such as ethanol, ethyl alcohol, and/or alcohol, may be utilized to help separate dissolved substances from the supercritical fluid after extraction. An adsorbent may cause a pressure drop across the adsorbent section enabling an efficient separation of dissolved substances from the extraction fluid. Further, alcohol based adsorbents remove beneficial lecithin from the dried egg yolk and cause the egg yolk to loose its color. In another embodiment, the present invention does not utilize adsorbents to separate the dissolved substances from each other because no phospholipids are absorbed into supercritical fluid that need to be individually separated for reinsertion into the dried egg yolk, only triglycerides and/or cholesterol are absorbed, which are easily separated from the supercritical fluid simply by reducing pressure. Therefore, the present invention may avoid the problems associated with utilizing adsorbents.

The pressure drop necessary to separate cholesterol and/or triglycerides from the supercritical fluid may change the supercritical fluid from its desired pressure and temperature ranges. In those instances, the extraction fluid may pass through a supercritical recycler 112, where the temperature and/or pressure of the extraction fluid may be adjusted to within the desired operating range to prepare the extraction fluid for additional extraction in extractor 106.

For instance, where reducer 110 reduced the temperature or pressure of the extraction fluid, the gaseous extraction fluid may pass to supercritical recycler 112 (FIG. 3). Supercritical recycler 112 may utilize energy to increase the temperature, pressure, or both of the extraction fluid such that a supercritical state is obtained. For example, supercritical recycler 112 may comprise heating devices, pressure devices, or a combination of heating and pressure devices. Heating devices may comprise plate heat exchangers, shell and tube heat exchangers, circulation heaters, forced air duct heaters, and other suitable heating devices. Pressure devices may comprise centrifugal, vertical, or rotary screw pumps, and compressors, such as axial flow, reciprocating, and centrifugal compressors, or other suitable pressure devices. Thus, the extraction fluid is prepared for additional extraction in extractor 106 (FIGS. 3). In one embodiment, where screening agents are utilized, the extraction fluid remains in the supercritical state and may not require supercritical recycler 112.

V. Reconstitutor

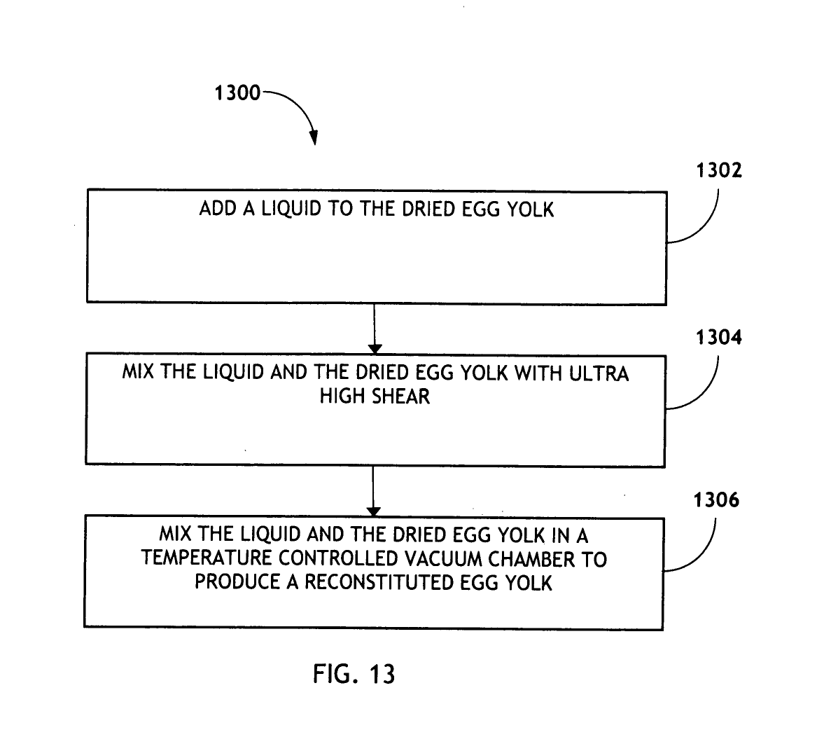

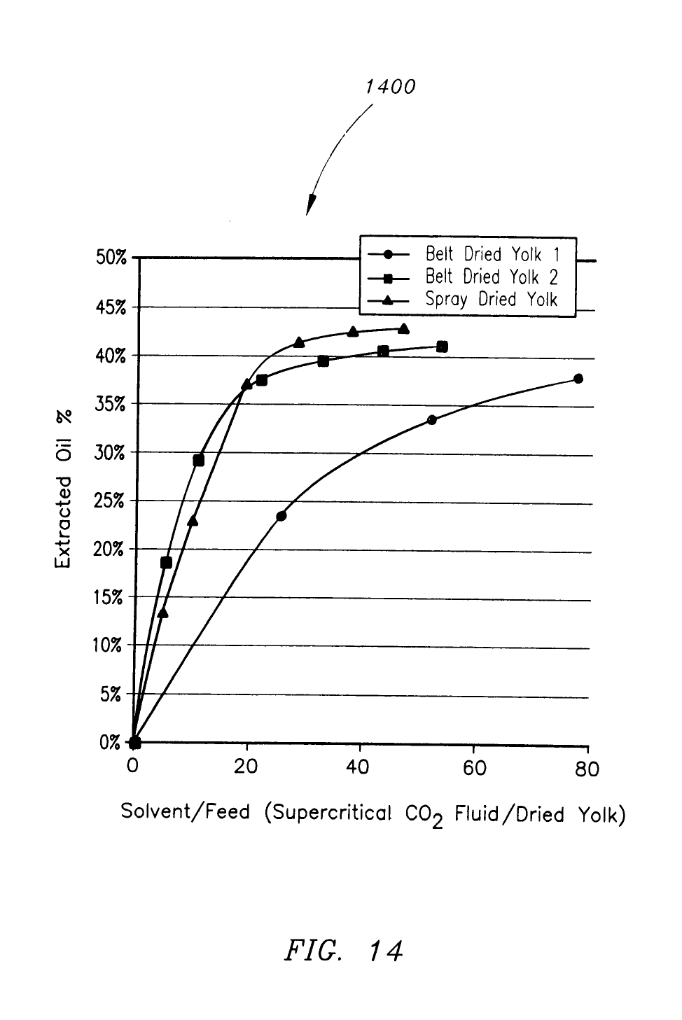

The cholesterol reduced and/or fat reduced egg yolk may then be reconstituted. Referring to FIG. 13 a method 1300 for reconstituting dried egg yolk is shown in accordance with the exemplary embodiments of the present invention. The method 1300 adds a liquid to the dried egg yolk 1302. The method 1300 mixes the liquid and the dried egg yolk with ultra high shear 1304. Method 1300 mixes the liquid and the dried egg yolk in a temperature controlled vacuum chamber to produce a reconstituted egg yolk 1306.

The reconstitution method of the present invention is more effective and more efficient than previously utilized methods because the present invention may utilize a closed system, controlled temperatures, a vacuum pump, honeycomb type structures formed by the vacuum belt dryer, small particles with low densities formed by spray drying, and/or ultra high shear mixing. As previously stated, the honeycomb type structure formed by vacuum belt drying and the small particles formed by spray drying allow more liquid to penetrate the dried egg yolk for faster hydration for a more efficient reconstitution. Additionally, reconstitution may be done under very low gauge pressure in a vacuum (e.g., 25-28 in. Hg vacuum) with temperature control to prevent air entrapment, to prevent oxidation, and to develop smooth texture of the liquid yolks making the present invention more effective.

Furthermore, the reconstitution method of the present invention is more efficient and more effective because the method utilizes ultra high shear mixing with high RPM, high tip speed, and with low temperature control for faster and better reconstitution by preventing any solid particles from remaining while the controlled temperature helps prevent proteins from denaturing. The RPM and tip speed may vary depending upon the size/diameter of the storage tank and the size/width/diameter of the blade utilized.

Referring to FIG. 2, a partial system flow diagram for an exemplary embodiment of the reconstitutor 108 as illustrated in FIG. 1 is shown. Reconstitutor 108, for example, may comprise a particle conditioner 114, a high shear mixer 116, and a mixer 118 as illustrated in FIG. 2. In one embodiment, the yolk product from extractor 106 may be treated in particle conditioner 114 prior to being reconstituted. For example, particle conditioner 114 may comprise a flow of non-toxic, inert gas, such as nitrogen, to prevent oxidation of the yolk product. For instance, the yolk product may first be aspirated by a device, such as a venturi (including a venture tube), which dilutes the yolk product in a stream of nitrogen, other suitable gas, or gas mixture. The yolk product in this embodiment of the present invention then exits the venturi by the force of a fast moving turbulent gas jet which provides a shearing force on the particles high enough to break up any loosely bound aggregates. The reduced particle size may enhance the reconstitution of the yolk product in high shear mixer 116, by providing increased yolk product surface area to contact water. However, additional particle conditioning may not be required, depending on the structure and size of the yolk product particles.

After the particle conditioning, the yolk product is then reconstituted in high shear mixer 116, as illustrated in FIG. 2. For example, high shear mixer 116 may provide high speed mixing, such as through a blender, to ensure a thorough blending of the yolk product and the added water. Additionally, high shear mixer 116 may be under vacuum and temperature control, to optimize blending or reconstituting conditions. For example, ultra high shear mixing and a full vacuum with up to 28 inches of Hg vacuum may be utilized during reconstitution.

Reconstituting may be done by some form of mechanical working, such as mixing, agitating, blending, or another suitable method. For example, reconstitutor 108 (FIG. 2) may comprise an agitator or multi-agitator mixer, blender, continuous mixer, static mixer, disperser, drum or rotary drum mixer, vacuum mixer, emulsifier, or other device suitable for combining the feed into the desired egg product (FIGS. 1, 2, 3, and 5).

In one embodiment, the yolk product from extractor 106 is first combined with water under high shear stress to produce a reconstituted egg yolk. For example, one part egg yolk, with desired and healthful composition, to two to five parts water (1:2 to 1:5) may be combined (per weight basis). This ratio will vary and must be controlled accordingly for different end products to satisfy consumer needs and preferences. The reconstitutor 108 (FIG. 2) may homogenize the reconstituted yolk with the egg white product and other additional ingredients. In order to obtain a desirable homogenized product, the time and temperature of reconstitutor 108 (FIG. 2) may be controlled.

In another embodiment, liquid, such as water, that is fed into high shear mixer 116 may be proportionally controlled, such that the desired hydration level of the reconstituted yolk is achieved. For example, a programmable control valve may govern a water inlet pipe. The product of high shear mixer 116 may be a yolk slurry, which is fed into mixer 118. The yolk slurry, for instance, may be combined with egg white product, in addition to other possible ingredients, such as vegetable matter, spices, ham, bacon, bacon substitutes, sausage, cheese, and other desired substances. This list is exemplary only and is not meant to be restrictive of the present invention. It is contemplated that a variety of substances may Is be utilized in the present invention. The egg white product may be obtained from the separation step in separator 102 or from an independent source for reconstitutor 108 (FIG. 2). Consumer preference may dictate the appropriate ratio for the best flavor and organoleptic qualities. Mixer 118 blends the egg white product, yolk slurry, and ingredient feeds to produce the egg product, which may be homogenously mixed.

The reconstituted yolk and the egg white product may be combined such that the liquid weight ratio of reconstituted yolk to egg white product (yolk %:egg white %) is approximately equal to the natural whole egg ratio (e.g., 35%:65%). However, the ratio may vary, depending on consumer preference of the egg product. For instance, consumers may prefer additional yolk flavor to compensate for the reduction in saturated fats (e.g., 40%:60%), or consumers may prefer more egg white product for additional foaming properties (e.g., 30%:70%). Other ratios may comprise a ratio of 7 parts reconstituted yolk to 93 parts egg white product.

However, the reconstituted egg yolk is not limited to combinations with egg white product. A feed different from egg white product may be introduced into reconstitutor 108 (FIG. 2). For example, reconstituted egg yolk can be combined in various proportions with a pourable omelet mix to improve consumer preference and sensory experience of this product. The above-mentioned proportions may all be optimized and change depending on the requirements of differing desired egg comprising food products, such as egg nog, souffle mix, liquid egg products, and the like. For example, egg containing food products comprise food products that utilize an egg ingredient, such as mayonnaise, egg nog, omelets, liquid egg products, custard, baked goods, ice cream, meringue, and aerosol based creams. This list is exemplary only and is not meant to limit or restrict the present invention. It is understood that other egg containing food products may be utilized without departing from the scope and spirit of the present invention. Thus, the product of reconstitutor 108 (FIG. 2) is the desired egg product of system 100.

Additionally, the reconstitutor system may comprise purges (not shown in the figures). However, in the present invention the use of a dried egg yolk with a permeable structure, such as a honeycomb type structure or the low densities of the small particle size formed by a spray dryer, increases the extractor efficiency reducing the frequency of needed purges.

For instance, purges in the recycle streams may purge material from the system to prevent a continuous mass buildup within reconstitutor 108 (FIG. 2). For example, where system 100 operates outside of desired ranges for a period of time, the recycle streams may need to be varied to adjust for the method inefficiencies, and some recycled material may need to be purged to prevent a buildup of that material within the system. Purging may reduce the energy requirements for transporting an excess of materials and also may avoid difficulties in maintaining the desired proportion of egg white product to reconstituted yolk.

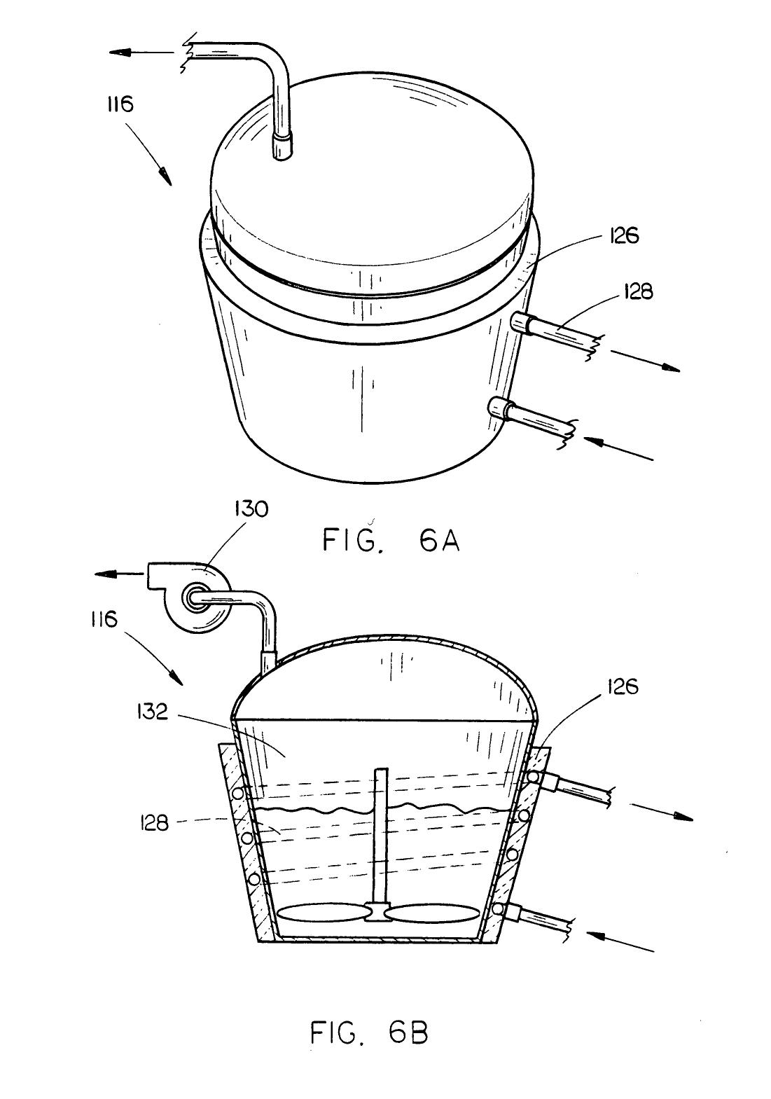

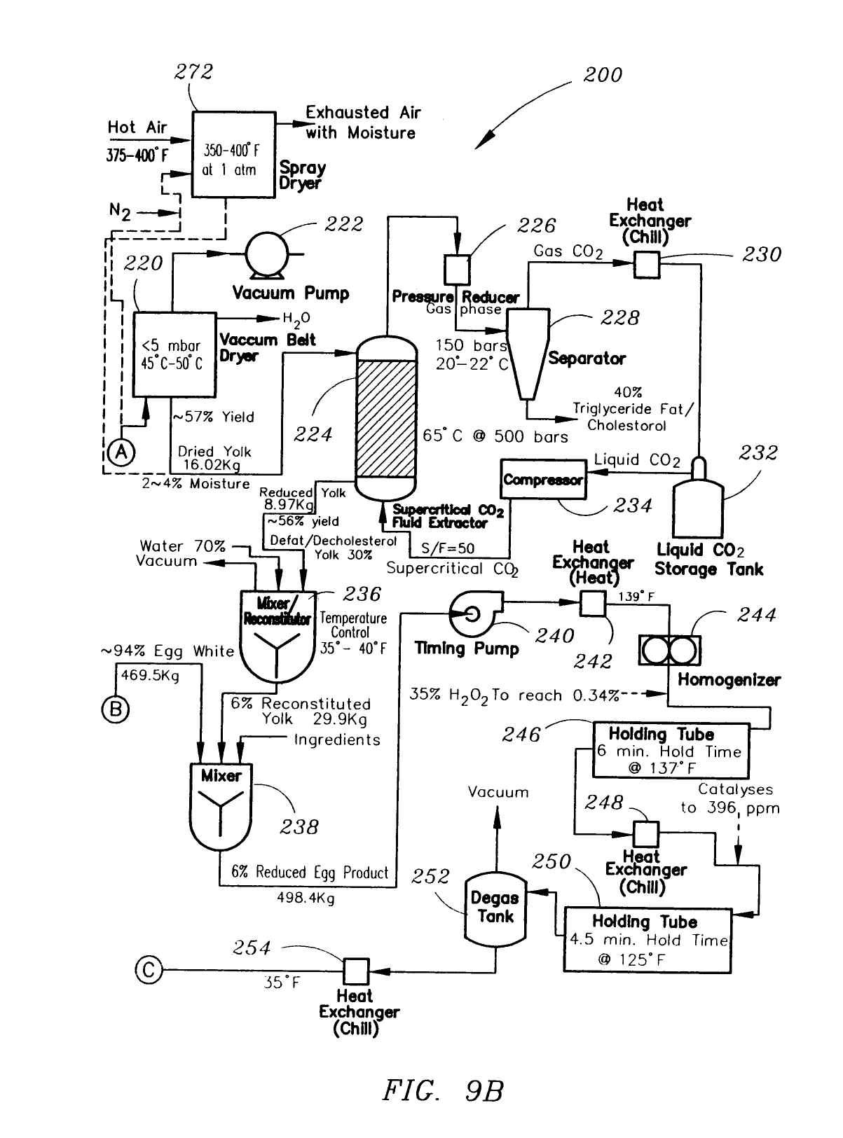

Referring now to FIGS. 6A and 6B, an exemplary embodiment of the high shear mixer 116 of the reconstitutor 108 illustrated in FIGS. 1, 2, 3, and 5 and the mixer/reconstitutor 236 illustrated in FIG. 9 is shown. The high shear mixer 116 and the mixer/reconstitutor 236 include an insulated compartment 126. In one embodiment, the insulated compartment 126 comprises a tube 128 that a cooling medium may be pumped through. In a specific embodiment, the cooling medium is a glycol fluid. The liquid added to reconstitute the egg yolk powder will also be kept at a cool temperature. The liquid and the dried egg yolk are added to the vacuum chamber 132 of the high shear mixer 116 or the mixer/reconstitutor 236. The cooling medium and the added liquid (e.g., water) will maintain a temperature in the high shear mixer 116 or the mixer/reconstitutor 236 of about 40° F. and below. In another specific embodiment, a glycol fluid cooling medium will be added to the insulated compartment 126 at about 28° F. In one embodiment, the high shear mixer 116 or the mixer/reconstitutor 236 will mix the liquid and the extracted dried egg yolk with ultra high shear or at about 3000 RPM for about 6 minutes. Additionally, the high shear mixer 116 or the mixer/reconstitutor 236 may include a vacuum 130 that exerts up to 28 inches of Hg vacuum of gauge pressure. In a specific embodiment, the vacuum will exert about 25 inches of Hg vacuum of gauge pressure. In another embodiment, about 10 lbs of extracted egg yolk powder is added with about 23.33 pounds of ice water. In another specific embodiment, vacuum chamber 132 holds up to 58 liters of liquid, has a diameter of about 50 cm, and has a 35 cm blade that may reach a speed of about 3600 RPM.

VI. Product Finishing

Referring now to the exemplary embodiment of FIG. 8, a flow diagram of a system for product finishing is shown in accordance with an exemplary embodiment of the present invention. In this embodiment of the present invention, following the reconstituting step, the egg product may go through a product finishing step before the egg product is consumer ready.

A. Pasteurizer

For example, the egg product may be pasteurized in a pasteurizer 120, to eliminate harmful microorganisms within the egg product and to extend the shelf life of the egg product. The reconstituted egg product may be pasteurized by any of the previously described pasteurization methods under Section II.

In one embodiment, the pasteurizer of the present invention pasteurizes reduced cholesterol and/or triglyceride whole egg and reduced cholesterol and/or triglyceride egg yolk. Previously utilized pasteurization methods, typically, pasteurize egg white separately from egg yolk because the higher levels of proteins and phospholipids in the egg yolk made the product more susceptible to denaturization. Moreover, the reduction of triglycerides and cholesterol increases the total percentage of proteins and phospholipids in the egg yolk making this product even more difficult to pasteurize without denaturization. The present invention may pasteurize the egg white and egg yolk together and is therefore more efficient because it only utilizes one pasteurizing machine, so only one machine has to be cleaned.

The reconstituted egg product may contain egg white and therefore may also contain the egg white's desirable proteins. Heating pasteurization denatures the proteins of bacteria and other microorganisms to deactivate them. However, if the heat level exceeds the tolerance level of the egg product, then the egg proteins of the egg white and egg yolk will also denature. In one embodiment, compounds such as acids, aluminum sulfate, or cysteine and mixture thereof may be utilized to prevent egg white protein denaturization by allowing increased temperatures to be utilized during pasteurization and processing without denaturing egg proteins. Additives, such as acids, aluminum sulfate, and cysteine may be utilized to prevent egg proteins from denaturing in temperatures up to 140° F. if the pH of the egg white is lower than 8.4. For instance, the methods disclosed in U.S. Pat. No. 3,251,697; U.S. Pat. No. 7,005,158; U.S. Pat. No. 5,455,054; U.S. Pat. No. 5,266,338; and U.S. Pat. No. 5,096,728 for increasing the temperature necessary to denature egg white proteins may be utilized and are herein incorporated by reference.

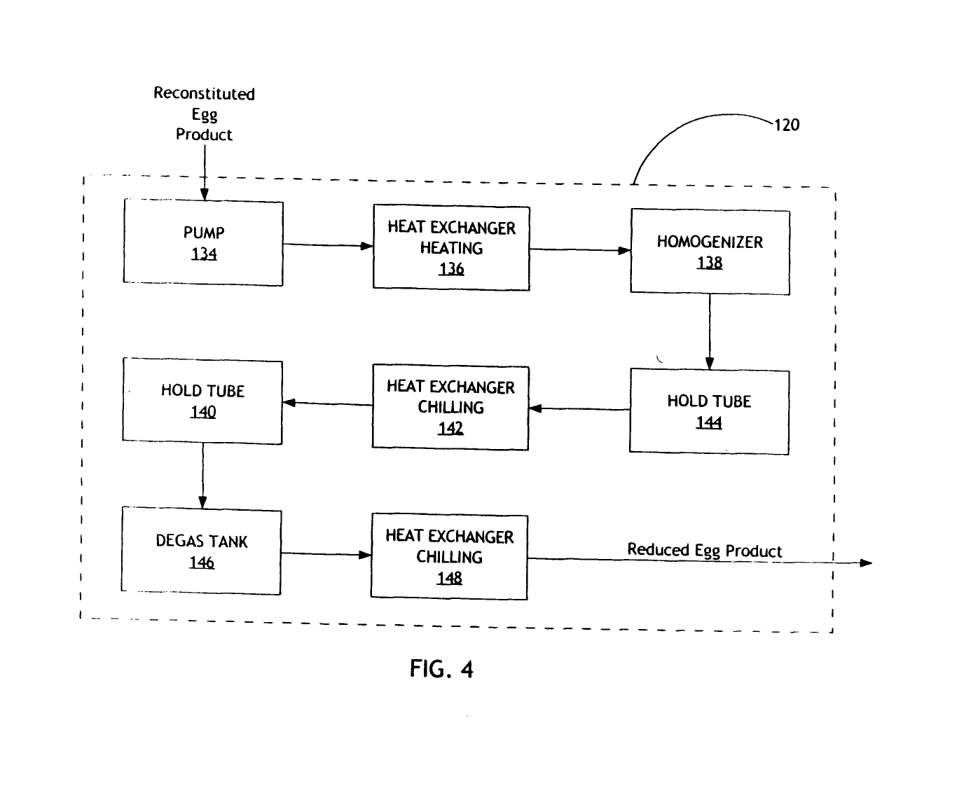

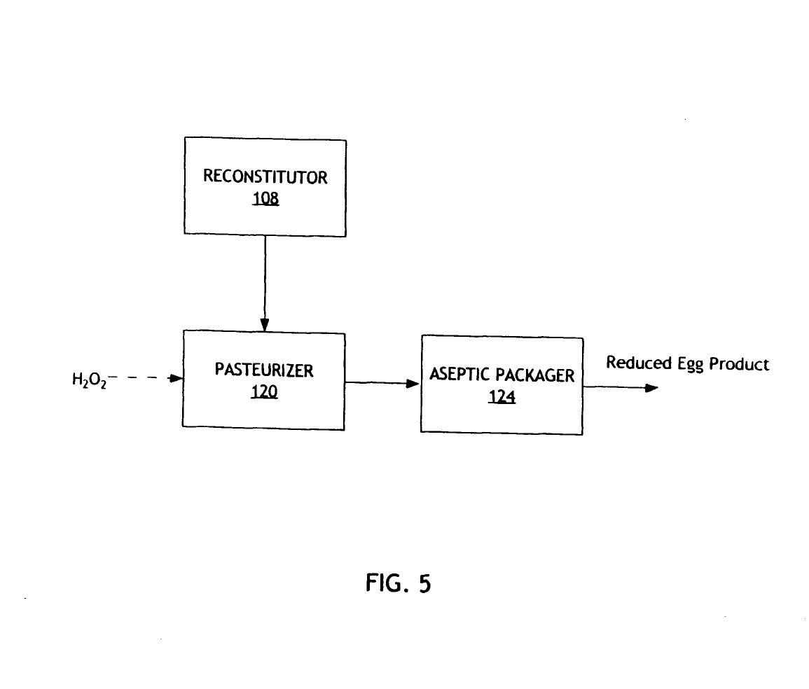

In one embodiment, the pasteurizer 120 consists of multi-stage heating technology as illustrated in FIG. 4. Referring now to FIG. 4 a partial flow diagram of the system illustrated in FIG. 5 further illustrating the pasteurizer is shown in accordance with the exemplary embodiments of the present invention. The reconstituted egg product is pumped by a pump 134 into a heat exchanger 136, homogenizer 138, hold tube 144, heat exchanger 142, hold tube 140, degas tank 146, and heat exchanger 148. Heat exchanger 136 heats the reconstituted egg product up so that it leaves the heat exchanger 136 at a temperature of about 139° F. In one embodiment, after homogenization H₂O₂ may be added to the egg product. The homogenized product is sent through hold tube 144 for about six minutes at 137° F. and then through another heat exchanger 142 that chills the egg product so that it leaves heat exchanger 142 at a temperature of about 126° F. In another embodiment, 396 ppm of catalyses may be added to the egg product after flowing through heat exchanger 142. Hold tube 140 contains the egg product for about 4.5 minutes at 125° F. Degas tank 146 may include a vacuum. Heat exchanger 148 chills the egg product so that it is at a temperature below 35° F. when it leaves heat exchanger 148.

B. Packager

After pasteurizing, in a further embodiment, the egg product may be aseptically packaged in an aseptic packager 124, as illustrated in FIG. 8. For example, aseptic packager 124 may comprise an aseptic surge tank for holding the egg product in a decontaminated environment. Additionally, for instance, aseptic packager 124 may comprise multiple filling equipment configured to receive the egg product from the aseptic surge tank and to deliver specific charges of egg product into various product containers. Thus, different end product package sizes may be made available to consumers.

### EXAMPLE 1

Referring now to FIG. 9, a more specific exemplary embodiment of the present invention is shown. The product of system 200, as illustrated in FIG. 9, is a reduced egg product of the present invention, comprising natural egg white and egg yolk components, along with other potential components, but having reduced triglycerides and cholesterol without extracting phospholipids, such as lecithin and cephalin.

For example, 100 kg of whole eggs are inserted into an egg breaker/separator 202 that is substantially equivalent to the previously described separator 102 shown in FIG. 1. The egg breaker/separator 202 produces 15.3 kg of shells, 56.6 kg of egg white, and 28.1 kg of egg yolk.

The egg yolk is pasteurized by being fed into a mixer 204 with process aids/antioxidants, such as fiber, sorbitol, maltodextrose, maltodextrin, egg white, starch, vitamin E, vitamin C, and rosemary extract; a timing pump 208; a heat exchanger heating 210; a holding tube 212 for 5 to 7 minutes at 144° F. to 146° F.; a homogenizer 206; and a heat exchanger chilling 214, as illustrated in FIG. 9. Next, the egg yolk is held in a storage tank 216, which feeds the egg yolk through a pump 218. Pump 218 feeds the egg yolk into a vacuum belt dryer 220 with a vacuum pump 222 or into a spray dryer 272. In an alternative embodiment, heat exchanger chilling 214 may not be utilized and instead the heated egg yolk from the holding tube may be pumped directly into the vacuum belt dryer 220 or the spray dryer 272 while still warm to improve efficiency and reduce the chance of oxidation.

The vacuum belt dryer 220 and spray dryer 272 are the same as the vacuum belt and spray dryers 104 as previously described in system 100. A temperature gradient of about 45° C. to about 90° C. is utilized inside the vacuum belt dryer 220 with a pressure of less than 5 mbar. The vacuum belt dryer 220 yields about 16.02 kg of dried egg yolk with a honeycomb type structure that comprises about 3% to about 4% moisture allowing for a more efficient cholesterol and triglyceride extraction. A temperature of about 350° F. to about 400° F. at one atmosphere of pressure is utilized in the spray dryer 272. Prior to entering the spray dryer N₂ is added to the liquid egg yolk. Hot air at a temperature of about 375° F. to about 400° F. enters the spray dryer and exits through an exhaust containing the extracted moisture from the liquid egg yolk. The spray dryer 272 yields about 16.02 kg of dried egg yolk in small particles with low densities that comprise about 2% to about 4% moisture allowing for a more efficient cholesterol and triglyceride extraction.

In another embodiment, the dried yolk is fed from the vacuum belt dryer 220 or the spray dryer 272 to the supercritical CO₂ fluid extractor 224 and exposed to supercritical CO₂ fluid at about 500 bar and about 65° C., which extracts triglycerides and cholesterol and selectively does not extract phosphotipids, as illustrated in FIG. 9. The supercritical CO₂ fluid, after absorbing cholesterol and triglycerides, is fed into a pressure reducer 226, which turns the supercritical CO₂ fluid into a gas phase. The gas phase CO₂ is fed through a separator 228 at about 600 psi to about 800 psi and at about 15° C. to about 40° C. to separate the triglycerides and cholesterol from the gas phase CO₂. In a specific embodiment, the separator 228 may utilize a temperature of about 21° C. to about 22° C. at about 150 bar. In another embodiment, the separator 228 may have an about 39% to an about 40% yield of extracted oil or triglycerides and/or cholesterol. The separator 228 feeds the gas CO₂ through a heat exchanger 230 at a temperature below 20° C. that turns the gas CO₂ back into a liquid. The liquid CO₂ is fed into a storage tank 232, which may recirculate the liquid CO₂ back to the supercriticat CO₂ fluid extractor 224 by feeding the CO₂ through a compressor 234 to obtain the proper temperature and pressure to form the proper absorptive supercritical CO₂ fluid for extraction. About 50 pounds of supercritical CO₂ is utilized for one pound of dried egg yolk in the extractor 224. Furthermore, the extractor 224 produces about 8.97 kg of reduced egg yolk.

In one embodiment, the triglyceride and/or cholesterol reduced yolk produced by the supercriticat CO₂ fluid extractor is fed into a mixer/reconstitutor comprising a vacuum 236 with water at about 30° F. to about 45° F, as illustrated in FIG. 9. For instance, the mixer/reconstitutor may utilize ultra high shear mixing with a full vacuum up to 28 inches of Hg vacuum of gauge pressure. For example, the mixture by total weight may be about 70% water and about 30% cholesterol and/or triglyceride reduced egg yolk. The 29.9 kg of reconstituted yolk may then be fed into a mixer 238 with ingredients, such as vegetable matter, spices, bacon, ham, bacon substitute, cheese, and egg white product. For example, the composition by total weight may comprise about 85% to about 98% egg white, about 1% to about 10% cholesterol and triglyceride reduced egg yolk, and about 0% to about 5% other ingredients.

The egg white product added into the mixer 238 is from the separated egg white produced by the egg breaker/separator 202, as illustrated in FIG. 9. The separated egg white product from the egg breaker/separator 202, in one embodiment of the present invention, is pasteurized by being fed into a timing pump 260, heat exchanger heating 262, homogenizer 258, holding tube 264 at about 139° F. to about 140° F. for about 5 to about 7 minutes, and then another heat exchanger chilling 266. After pasteurization, the egg white product is pumped either directly into a storage tank 270 or into a mobile storage tank 268, which is transported to another location and then pumped into storage tank 270.

The egg white product from storage tank 270 is fed into mixer 238 with the reconstituted yolk and ingredients and mixed. In one embodiment, pasteurized simulated egg white may be added to the egg white product before being fed into mixer 238. In another embodiment, pasteurized or unpasteurized simulated egg white may be added to the separated egg white prior to pasteurization. In a specific embodiment, the mixer 238 contains about 94% or 469.5 kg of egg white product and about 6% or 29.9 kg of reconstituted yolk by weight to the total mixture. In a specific embodiment, the ingredients added to the mixer 238 may comprise simulated egg yolk, bacon, cheese, vegetables, flavorings, and or other additives.

The mixer 238 produces about 498.4 kg of the reconstituted yolk, egg white product, and ingredients mixture. In a specific embodiment, the reconstituted yolk, egg white product, and ingredients mixture is pasteurized by being fed into a timing pump 240; a heat exchanger 242; a homogenizer 244; a holding tube 246 at about 130° F. for about 6 minutes with optional hydrogen peroxide; another heat exchanger 248; another holding tube 250 at about 125° F. for about 4.5 minutes with optional catalyses (e.g., 396 ppm of catalyses); a degas tank with a vacuum 252; and then a further heat exchanger 254, as illustrated in FIG. 9. Heat exchanger 242 heats the egg product to a temperature of about 139° F. Heat exchanger 254 cools the egg product to a temperature below 35° F. The pasteurized mixture is fed into an aseptic storage tank 256, which feeds the mixture into an aseptic filler resulting in a pasteurized egg product.

### EXAMPLE 2

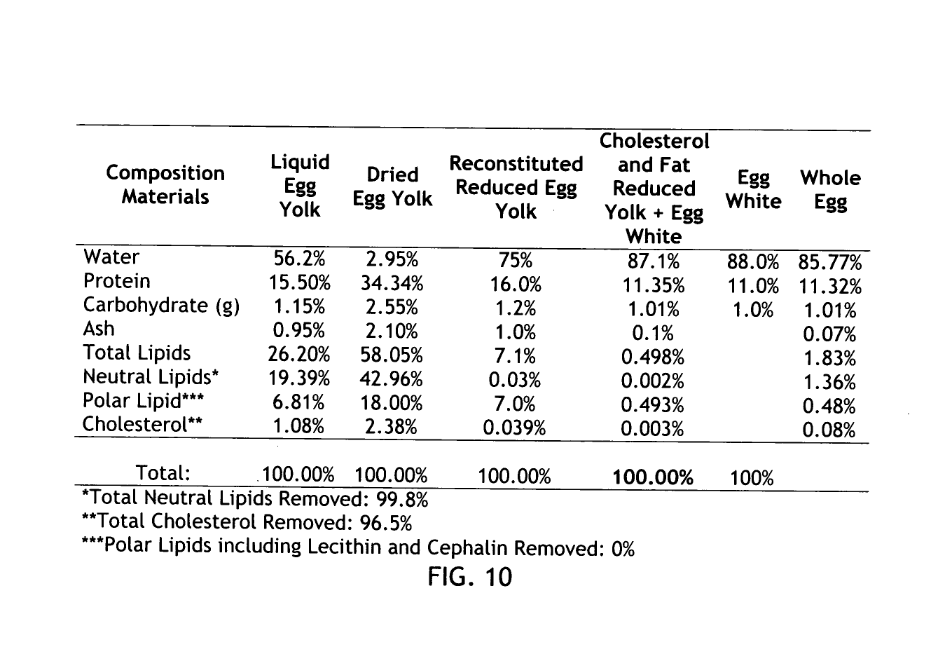

FIG. 10 provides exemplary percentages by weight of various components throughout steps of system 100 and 200 (where Neutral lipids and Polar lipids are presented as sub-components of Total Lipids): where Liquid Egg Yolk is the feed into dryer 104 and 220, Dried Egg Yolk is the product of dryer 104 and 220, Reconstituted Reduced Egg Yolk is the product of extractor 106 and 224, Cholesterol and Fat Reduced Yolk+Egg White is the reconstituted yolk product and egg white mixture comprising about 30% by weight of reconstituted egg yolk of the present invention and about 70% by weight of egg white product, Egg White is the egg white fed into reconstitutor 108 (FIG. 2) or the mixer 238, and Whole Egg refers to a natural shelled whole egg. The weight percentages illustrated in FIG. 10 are exemplary only, and are not intended to limit the compositions of the materials within system 100 and 200 to the values listed.

The table of FIG. 10 demonstrates a 96.5% reduction in cholesterol and a 99.8% reduction in Neutral Lipids or triglycerides. Moreover, the table demonstrates the retention of phospholipids, (i.e., lecithin and Cephalin).

### EXAMPLE 3

The table below provides the percentages of extracted oil (extracted oil comprises cholesterol and triglycerides that have been extracted from the dried egg yolk by the supercritical fluid extractor) from the spray dried egg yolk as it was ran through the supercritical CO₂ fluid extractor utilizing 500 bar of pressure at 65° C. with an average flow rate of 28.2 kg/hr for different time increments.

| | | | Accumulated | | CO₂/Dried |
|---|---|---|---|---|---|
| Time | Extract Oil | | Extracted | CO₂ used | Yolk Wt |
| (hr) | Wt (g) | Extract % | Oil % | (kg) | Ratio (kg/kg) |
| 0 | 0 | 0 | 0.0% | 0 | 0 |
| 0.25 | 211.9 | 13.7% | 13.7% | 7.4 | 4.78 |
| 0.5 | 146.8 | 9.5% | 23.2% | 7.4 | 9.56 |
| 1 | 219.6 | 14.2% | 37.4% | 14.7 | 19.06 |
| 1.5 | 66.2 | 4.3% | 41.7% | 14 | 28.11 |
| 2 | 16.7 | 1.1% | 42.7% | 13.7 | 36.97 |
| 2.5 | 5.8 | 0.4% | 43.1%* | 13.3 | 45.56 |

*Represents a 98% extraction of triglycerides and 96% extraction of the cholesterol

(1547 grams of spray dried egg yolk entered the extractor and 875.6 grams of cholesterol and fat reduced egg yolk left the extractor). This table demonstrates that the amount of oil extracted in the extractor increases until about one hour. This table also demonstrates the high percentages of extraction (98% extraction of triglycerides and 96% extraction of the cholesterol) that are achieved by utilizing the spray dryer and the specific extractor parameters of the present invention. Furthermore, the table demonstrates that for every 1 pound of egg yolk utilized 45.56 pounds of CO₂ will be utilized because the final CO₂/Dried Yolk Weight Ratio is 45.56. While the flow rate of CO₂ and the amount of time necessary for full extraction may vary, the CO₂/Yolk Weight Ratio will stay at the constant 45.56 pounds of CO₂ per one pound of egg yolk.

### EXAMPLE 4

Differential scanning calorimetry (DSC) was utilized to show protein stability (or insubstantial protein denaturization) in the cholesterol and fat reduced egg yolk of the present invention. DSC is a thermodynamic technique that shows if a protein has been denatured by measuring the difference in the amount of heat required to increase the temperature of a sample and a reference, which are measured as a function of temperature. The DSC analysis of fresh egg in a gold plated pan compared to three different reconstituted egg yolks of the present invention in a gold pan is shown in the table below:

Reconstituted Cholesterol and Fat Reduced Egg Yolk
(30% reduced dried egg yolk and 70% water)

| | Temp | Peak | | |
|---|---|---|---|---|
| | Range | Temp | Enthalpy | Density |
| | ° C. | ° C. | mJ/mG | g/cm³ |
| fresh egg yolk (Gold plated pan) | 55.8-89.5 | 80.8 | 2.27 | |
| fresh egg yolk (Gold plated pan) | 55.8-89.4 | 80.2 | 2.68 | |
| fresh egg yolk (Gold plated pan) | 57.0-90.1 | 79.7 | 2.04 | |
| 400 Bar 45° C. with 3% processing aid | 62.2-90.0 | 78.1 | 2.33 | 1.0752 |
| 400 Bar 45° C. with 3% processing aid | 62.4-89.4 | 77.1 | 2.70 | |
| 400 Bar 45° C. with 3% processing aid | 62.3-90.1 | 77.1 | 2.55 | |
| 400 Bar 45° C. with 3.5% processing aid | 62.3-90.5 | 78.1 | 1.92 | 1.0773 |
| 400 Bar 45° C. with 3.5% processing aid | 60.6-89.5 | 78.4 | 2.19 | |
| 400 Bar 45° C. with 3.5% processing aid | 63.3-89.8 | 77.4 | 2.09 | |
| 400 Bar 45° C. with 3.5% processing aid | 63.4-90.1 | 77.8 | 2.03 | |

(The reconstituted egg yolk of the present invention was mixed with either a 3.5 % or 3% processing aid by weight of the liquid egg yolk before extraction and ran through the supercritical fluid extractor with about 400 bar of pressure at 45° C.). Because different proteins will denature at different temperatures in the egg yolk, a temperature ranges was measured for the different products. Essentially, the less energy utilized, the more denaturization of a protein. The table shows that the maximum peak temperature difference between the fresh egg yolk and the egg yolk of the present invention is 3.5° C. or less. Moreover, the enthalpy difference for the highest temperatures is at most −0.01 mJ/mG for the egg yolk with added processing aid of 3.5% by total weight and the enthalpy difference for the highest temperatures for the added processing aid of 3% by total weight is at most 0.51 mJ/mG. The DSC showed small differences in enthalpy and peak temperatures for fresh liquid egg yolk and the egg yolk of the present invention; therefore, the egg yolk of the present invention has high protein stability or very little protein denaturization.

### EXAMPLE 5

A second separate DSC analysis was utilized to show the protein stability of the present invention. The dried egg yolk was put into a supercritical fluid extractor with 500 bar of pressure at 65° C. Two hundred gm samples of pasteurized and non-pasteurized fresh egg white and reduced egg product of the present invention (7% reconstituted cholesterol and fat Is reduced egg yolk and 93% fresh egg white by weight mixture) were cooked in a pan at varying temperatures for the DSC analysis. The results of this DSC analysis are shown in the table below:

| | |
|---|---|
| Peak Temp | Enthalpy |

| | AVG | STDEV | AVG | STDEV |
|---|---|---|---|---|
| DSC Results | (° C.) | (° C.) | (J/g) | (J/g) |
| Egg White with No | 81.45 | 0.40 | 1.82 | 0.11 |
| Pasteurization | | | | |
| Egg White Pasteurized | 81.68 | 0.29 | 1.95 | 0.31 |
| at 142° F. | | | | |
| Reduced Egg Product | 80.62 | 2.26 | 2.09 | 1.26 |
| of the Present | | | | |
| Invention | | | | |

The DSC shows that the peak temperature of pasteurized egg white and non-pasteurized egg white varies by about 1.06° C. without taking into account the standard deviations. Additionally, DSC shows that the enthalpy of pasteurized egg white and non-pasteurized egg white varies by about 0.27 J/g without taking into account the standard deviations. Again the DSC showed small differences in enthalpy and peak temperatures for fresh liquid egg white, pasteurized liquid egg white, and the egg yolk of the present invention; therefore, the egg yolk of the present invention has high protein stability or very little protein denaturization.

### EXAMPLE 6

The water release properties of the cholesterol and triglyceride reduced egg product were tested by utilizing a piston. A portion of the egg samples from the second DSC analysis of EXAMPLE 5 were cooked in a pan at 350° F. and then placed into a cylinder where a 425 g piston was placed on top of the cooked egg product for five minutes. The amount of water released from the samples was measured and is shown in the table below:

| | Water Release (g) for Fresh | | | Average | |
|---|---|---|---|---|---|
| Treatment | Egg White | | | Water | |
| Variables | Test1 | Test2 | Test3 | Release (g) | STDEV |
| not pasteurized | 15.4 | 14.9 | 14 | 14.77 | 0.71 |
| Pasteurized at | 12.9 | 9.9 | 8.9 | 10.57 | 2.08 |
| 142° F. | | | | | |
| | Water Release (g) for | | | | |
| | Cholesterol and Fat Reduced | | | | |
| Treatment | Yolk with Egg White | | | | |
| Variables | Test4 | Test5 | Test6 | | |
| not pasteurized | 13.5 | 13.1 | 15.9 | 14.17 | 1.51 |
| Pasteurized at | 6 | 6.1 | 6.6 | 6.23 | 0.32 |
| 142° F. | | | | | |

| | | Water loss | |
|---|---|---|---|
| Samples | Processing | average (%) | STDEV (%) |
| Fresh Egg White | no past | 7.38 | 0.35 |
| | 142 F. | 5.28 | 1.04 |
| Reduced Egg | no past | 7.08 | 0.76 |
| Product of the | 142 F. | 3.12 | 0.16 |
| Present Invention | | | |

The water release piston test shows that the egg product of the present invention actually lost on average less water than the fresh egg white samples without taking into account the standard deviations. Therefore, the egg product of the present invention has favorable water release properties.

### EXAMPLE 7

Furthermore, the water release properties of the cholesterol and triglyceride reduced egg product were tested by utilizing a centrifuge. A portion of the cooked egg samples utilized in the second DSC analysis of the water release study of EXAMPLE 6 were placed into a centrifuge tube and centrifuged at 10,000 RPM for 10 minutes. The amount of water released after this process was measure and is represented in the table below base on the total amount of water found in the egg samples:

| | | Water Loss | |
|---|---|---|---|
| | | Average | Stdev |
| Sample | Processing | (%) | (%) |
| Fresh Egg White | Not Pasteurized | 27.70 | 3.28 |
| | Pasteurized at 142° F. | 22.21 | 1.81 |
| Cholesterol and Fat | Not Pasteurized | 26.32 | 1.25 |
| Reduced Yolk + Egg White | Pasteurized at 142° F. | 21.30 | 1.10 |

The water release centrifuge test shows that the egg product of the present invention actually lost on average less water than the fresh egg white samples without taking into account the standard deviations. Therefore, the egg product of the present invention has favorable water release properties.

### EXAMPLE 8

The egg product of the present invention scored significantly better in consumer taste tests than egg products made with simulated egg yolk. For example, the study consisted of 112 subjects. Fifty percent of the subjects consume simulated egg products at least four times a month and the other 50% consume fresh whole eggs at least four times a month. Serving orders were randomized in the study to prevent order and position effects. The subjects tasted pasteurized whole egg, the egg product of the present invention (6% reconstituted reduced egg yolk with 94% egg white), and a whole egg product with simulated egg yolk. The subjects utilized a 9-point hedonic scale (ranging from 1=dislike extremely to 9=like extremely). The results of the study are shown in the table below:

| | Products | | |
|---|---|---|---|
| | | | Whole |
| | | Egg | Egg |
| | | Product | Product |
| | | of the | with |
| | Pasteurized | Present | Simulated |
| Attribute | Whole Egg* | Invention* | Egg Yolk* |
| Overall Product Liking | 6.7 a | 5.8 b | 5.0 c |
| Appearance Liking | 6.9 a | 6.5 ab | 6.0 cd |
| Overall Flavor Liking | 6.4 a | 5.7 b | 4.8 c |
| Overall Texture Liking | 6.5 a | 6.1 ab | 5.2 c |

*Means having different letters are significantly different at alpha = 0.1

This consumer taste test shows that the subjects rated the egg product of the present invention higher in all categories over the whole egg product with simulated egg yolk. Furthermore, this study illustrates that the largest increase between the egg product of the present invention and the whole egg product with simulated egg yolk occurred in overall flavor liking and overall texture liking, both increasing by almost a whole point on the 9-point hedonic scale. It is contemplated that the high scores for overall flavor liking and overall texture liking most likely result from the utilization of real egg yolk and the proteins found in real egg yolk and the increased protein stability of the present invention.

### EXAMPLE 9

A second consumer intensity taste test was done to measure the degree consumers' rate products as different or not different based on amount or intensity of specific attributes and does not indicate liking. The same 112 subjects of the previous consumer taste test from EXAMPLE 8 were given a 10-point categorical scale to rate their responses. The results of this study are shown in the table below:

| | Products | | |
|---|---|---|---|
| | | Egg | Whole Egg |
| | | Product of | Product |
| | | the | with |
| | Pasteurized | Present | Simulated |
| Attributes (1---10) | Whole Egg* | Invention* | Egg Yolk* |
| Color | 5.4 cd | 5.5 bc | 5.0 d |
| (Very Light ---Very Dark) | | | |
| Overall Flavor | 5.6 ab | 5.3 b | 4.5 c |
| (Very Weak---Very Strong) | | | |
| Egg Flavor | 5.6 ab | 5.0 bc | 4.4 c |
| (Very Weak---Very Strong) | | | |
| Saltiness | 2.5 c | 2.7 c | 2.8 bc |
| (Not at all Salty ---Very Salty) | | | |
| Moistness | 6.1 c | 7.6 a | 7.6 a |
| (Very Dry---Very Moist) | | | |
| Tenderness | 6.7 b | 7.3 a | 6.8 ab |
| (Not at all tender---Very | | | |
| tender) | | | |
| Denseness | 5.7 | 5.9 | 5.7 |
| (Not at all dense ---Very | | | |
| dense) | | | |
| Aftertaste | 4.2 c | 4.8 bc | 5.1 ab |
| (Very Weak ---Very Strong) | | | |

*Means having different letters are significantly different at alpha = 0.1

This table shows that the subjects thought the egg product of the present invention had a darker color, had a stronger overall flavor, had a stronger egg flavor, was less salty, was tenderer, and had less of an after taste than the whole egg product with simulated egg yolk.

### EXAMPLE 10

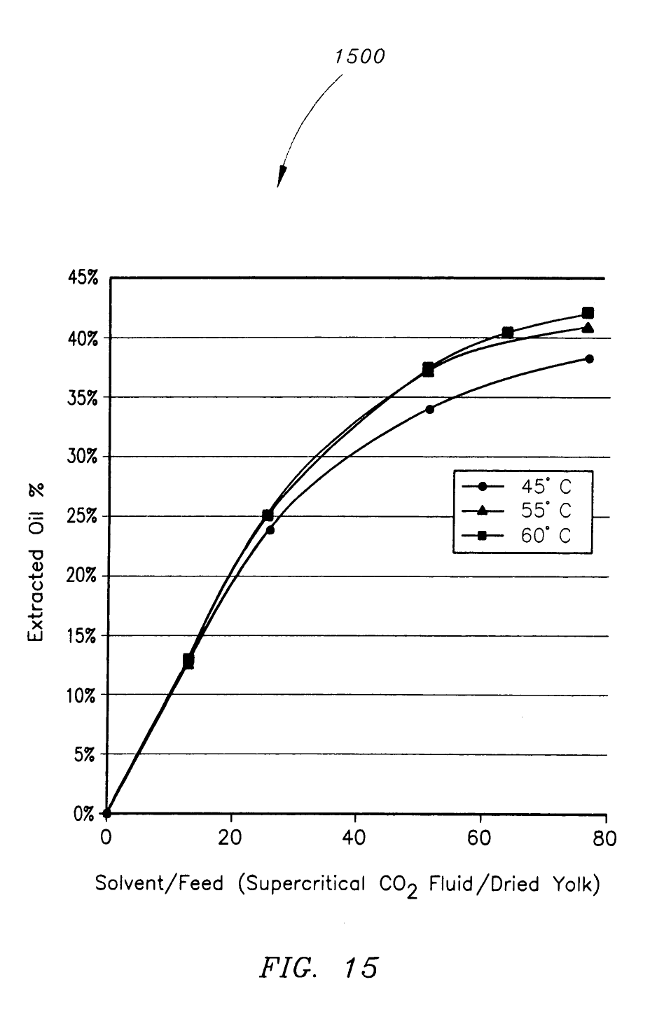

Referring now to FIG. 14, a graph illustrating a comparison of different supercritical CO₂ fluid extraction efficiencies 1400 for three dried egg products after supercritical fluid extraction, which utilized various extraction parameters and/or different drying methods, is shown in accordance with exemplary embodiments of the present invention. The three different extraction runs illustrated in FIG. 14 are entitled, Belt Dried Yolk 1, Belt Dried Yolk 2, and Spray Dried Yolk.

In Belt Dried Yolk 1, 200 grams of belt dried egg yolk mixed with a processing aid of 3% by weight was fed into an extractor at about 5 kg/hr with supercritical CO₂ fluid at a temperature of about 45° C. and a pressure of 4500 psi or about 310 bar. The processing aid dilutes the egg yolk decreasing the solvent to supercritical fluid ratio and decreasing efficiency. However, the processing aid facilitates a high drying rate and further promotes reconstitution. The extractor extracted 60.7% of the yolk by weight yielding 121.3 g of dried cholesterol and triglycerides reduced egg yolk after extraction. Several different measurements were taken of the egg product at set time increments during extraction. For example, the extracted oil weight, the oil extraction percentage, and accumulated oil extraction percentage, and the solvent/feed ratio or CO₂/Died Yolk ratio were recorded as shown below:

Belt Dried Yolk 1

| | Extracted | | Accumulate | |
|---|---|---|---|---|
| Time | Oil by | Extracted | Extracted | CO₂/Dried |
| (hr) | Weight (g) | Oil (%) | Oil (%) | Yolk (kg/kg) |
| 0 | 0 | 0 | 0 | 0 |
| 1 | 47.5 | 23.8% | 23.8% | 25 |
| 2 | 20 | 10.0% | 33.8% | 50 |
| 3 | 8.5 | 4.3% | 38.0% | 75 |

The extracted oil percentage in relationship to the CO₂/Dried Yolk ratio is illustrated in graph 1400 of FIG. 14.

In Belt Dried Yolk 2, 1428.9 g of belt dried egg yolk containing a processing aid of 3% by weight was fed at 29.6 kg/hr into an extractor with supercritical CO₂ fluid at temperature of 65° C. and a pressure of 500 bar. The extractor extracted 58.5% of the yolk by weight yielding 835.7 g of dried cholesterol and triglyceride reduced egg yolk after extraction. Several different measurements were taken of the egg product at set time increments. For example, the extracted oil weight, the oil extraction percentage, and accumulated oil extraction percentage, CO₂ usage, and CO₂/Dried Yolk ratio were all recorded for this example as shown below:

Belt Dried Yolk 2

| | Extracted | | Accumulate | CO₂ | |
|---|---|---|---|---|---|
| Time | Oil by | Extracted | Extracted | Usage | CO₂/Dried |
| (hr) | Weight (g) | Oil (%) | Oil (%) | (kg) | Yolk (kg/kg) |
| 0 | | 0 | 0 | 0 | 0 |
| 0.25 | 267.6 | 18.7% | 18.7% | 7.50 | 5.25 |
| 0.5 | 150.9 | 10.6% | 29.3% | 7.30 | 10.36 |
| 1 | 118.7 | 8.3% | 37.6% | 15.30 | 21.07 |
| 1.5 | 30.9 | 2.2% | 39.8% | 15.00 | 31.56 |
| 2.00 | 13 | 0.9% | 40.7% | 14.80 | 41.92 |
| 2.5 | 9.2 | 0.6% | 41.3% | 14.00 | 51.72 |

The extracted oil percentage in relationship to the CO₂/Dried Yolk ratio is illustrated in graph 1400 of FIG. 14.

In Spray Dried Yolk, 1547.4 g of spray dried egg yolk was fed at 28.2 kg/hr into an extractor with supercritical CO₂ fluid at temperature of 65° C. and a pressure of 500 bar. The extractor extracted about 56.6% of the yolk by weight yielding 875.6 g of dried cholesterol and triglyceride reduced egg yolk after extraction. Again, several different measurements were taken of the egg product at set time increments. For example, the extracted oil weight, the oil extraction percentage, accumulated oil extraction percentage, CO₂ usage, and CO₂/Dried Yolk ratio were all recorded for this example as shown below:

Spray Dried Yolk

| | Extracted | | Accumulate | CO₂ | |
|---|---|---|---|---|---|
| Time | Oil by | Extracted | Extracted | Usage | CO₂/Dried |
| (hr) | Weight (g) | Oil (%) | Oil (%) | (kg) | Yolk (kg/kg) |
| 0 | 0 | 0 | 0 | 0 | 0 |
| 0.25 | 211.9 | 13.7% | 13.7% | 7.40 | 4.78 |
| 0.5 | 146.8 | 9.5% | 23.2% | 7.40 | 9.56 |
| 1 | 219.6 | 14.2% | 37.4% | 14.70 | 19.06 |
| 1.5 | 66.2 | 4.3% | 41.7% | 14.00 | 28.11 |
| 2 | 16.7 | 1.1% | 42.7% | 13.70 | 36.97 |
| 2.5 | 5.8 | 0.4% | 43.1% | 13.30 | 45.56 |

The extracted oil percentage in relationship to the CO₂/Dried Yolk ratio is illustrated in graph 1400 of FIG. 14.

These examples show the high extractor efficiency of the present invention by showing a solvent/feed ratio or a supercritical CO₂ to Dried Yolk ratio of less than 80 for Belt Dried Yolk 1 and less than 60 for Belt Dried Yolk 2 and Spray Dried Yolk while extracting at least 84% of cholesterol and triglycerides. For example, the 38% Accumulated Extracted Oil percentage of the Belt Dried Yolk 1 signifies that 88.2% of the cholesterol and 90.5% of the triglycerides are removed from the spray dried yolk while maintaining a CO₂/Dried Yolk ratio of about 75. For instance, the 41.3% Accumulated Extracted Oil percentage of the Belt Dried Yolk 2 signifies that about 96.5% of the cholesterol and 98.8% of the triglycerides are removed from spray dried yolk while maintaining a CO₂/Dried Yolk ratio of about 51.72. Moreover, the 43.1% Accumulated Extracted Oil percentage of the Spray Dried Yolk signifies that about 98.69% of the cholesterol and 99.8% of the triglycerides are removed from the spray dried yolk while maintaining a CO₂/Dried Yolk ratio of about 45.56.

### EXAMPLE 11

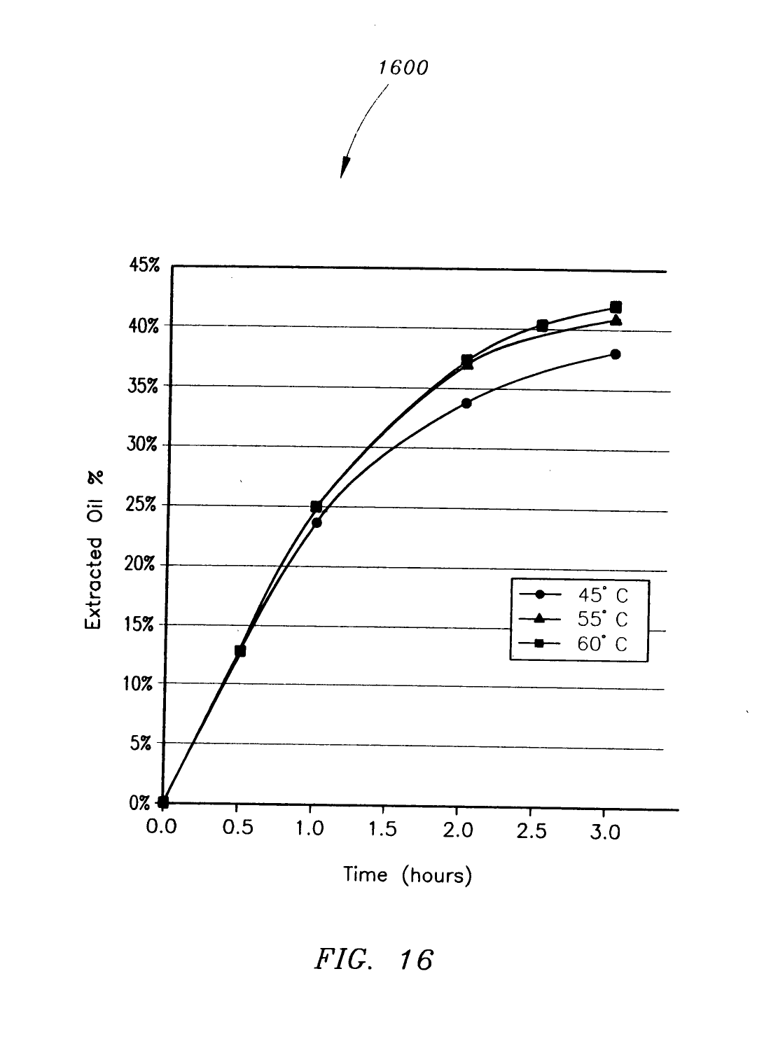

Referring now to FIG. 15, a graph illustrating a comparison of different supercritical CO₂ fluid extraction efficiencies 1500 for three dried egg yolk samples extracted at different temperatures is shown in accordance with exemplary embodiments of the present invention.

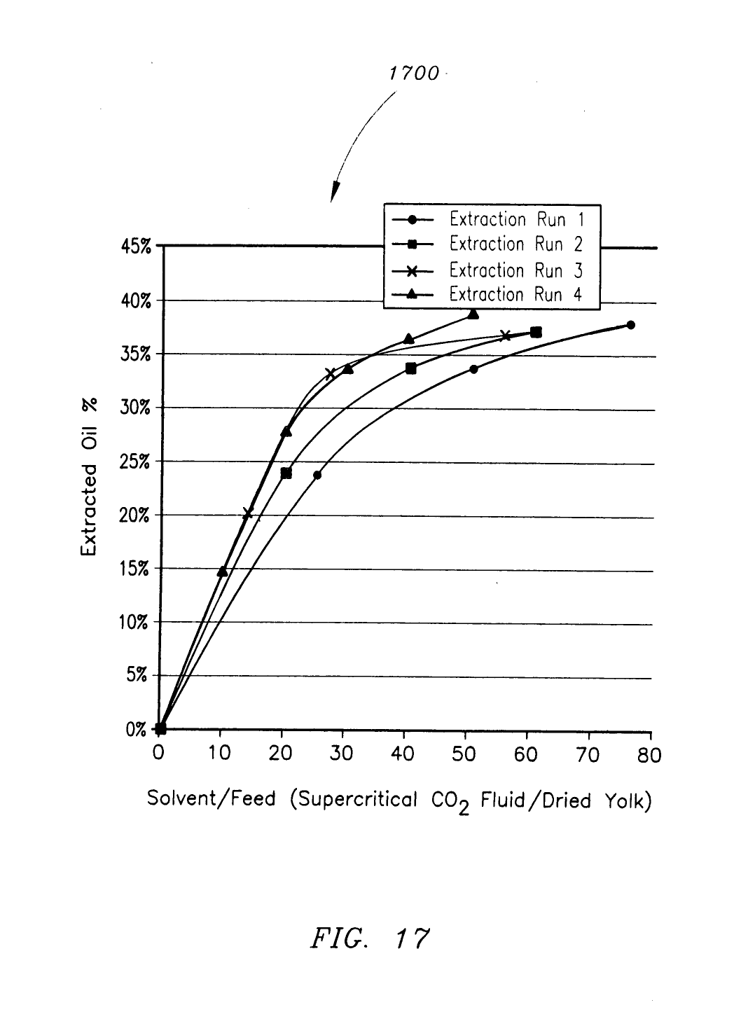

Referring now to FIG. 16, a graph illustrating a comparison of extracted oil percentage in relation to the overall time of extraction 1600 for the same three dried egg yolk samples utilized in FIG. 15 is shown in accordance with exemplary embodiments of the present invention.

All three samples were dried with a vacuum belt dryer and subject to extraction at a pressure of 4500 psi or about 310 bar. The first sample was extracted at a temperature of about 45° C. The second sample was extracted at a temperature of about 55° C. The third sample was extracted at a temperature of about 60° C. Several different measurements were taken of the three different egg products at set time increments. For example, the extracted oil weight, the oil extraction percentage, accumulated oil extraction percentage, and CO₂/Dried Yolk ratio were all recorded for these example as shown charts below:

Run 45° C.

| | Extracted | | Accumulate | |
|---|---|---|---|---|
| Time | Oil by | Extracted | Extracted | CO₂/Dried |
| (hr) | Weight (g) | Oil (%) | Oil (%) | Yolk (kg/kg) |
| 0 | 0 | 0 | 0 | 0 |
| 1 | 47.5 | 23.8% | 23.8% | 25 |
| 2 | 20 | 10.0% | 33.8% | 50 |
| 3 | 8.5 | 4.3% | 38.0% | 75 |

Run 55° C.

| | Extracted | | Accumulate | |
|---|---|---|---|---|
| Time | Oil by | Extracted | Extracted | CO₂/Dried |
| (hr) | Weight (g) | Oil (%) | Oil (%) | Yolk (kg/kg) |
| 0 | 0 | 0 | 0 | 0 |
| 0.5 | 25.2 | 12.6% | 12.6% | 12.5 |
| 1 | 24.8 | 12.4% | 25.0% | 25 |
| 2 | 23.9 | 12.0% | 37.0% | 50 |
| 3 | 7.5 | 3.8% | 40.7% | 75 |

Run 60° C.

| | Extracted | | Accumulate | |
|---|---|---|---|---|
| Time | Oil by | Extracted | Extracted | CO₂/Dried |
| (hr) | Weight (g) | Oil (%) | Oil (%) | Yolk (kg/kg) |
| 0 | 0 | 0 | 0 | 0 |
| 0.5 | 25.8 | 12.9% | 12.9% | 12.5 |
| 1 | 24.2 | 12.1% | 25.0% | 25 |
| 2 | 24.4 | 12.2% | 37.2% | 50 |
| 2.5 | 6 | 3.0% | 40.2% | 62.5 |
| 3 | 3.1 | 1.6% | 41.8% | 75 |

FIG. 15 illustrates the Accumulated Extracted Oil in relation to the Solvent/Feed ratio or CO₂/Dried Yolk ratio while FIG. 16 illustrates the Accumulated Extracted Oil in relation to extraction Time. Both graphs demonstrate that higher temperatures extract higher percentages of cholesterol and triglycerides than lower temperatures. For example, Run 45° C. has an accumulated oil percentage of 38%, which correlates to a 88.2% extraction of cholesterol and a 90.5% extraction of triglycerides, Run 55° C. has an accumulated oil percentage of 40.7%, which correlates to about 96% extraction of cholesterol and about 98% extraction of triglycerides, and Run 60° C. has an accumulated oil percentage of 41.8%, which correlates to about 99% extraction of cholesterol and about 99.2% extraction of triglycerides.

Moreover, like the previous example, the graph of FIG. 16 demonstrates the high extractor efficiency of the present invention because all of the extractors had a solvent/feed ratio or CO₂/Dried Yolk ratio of below 80 while extracting at least 84% of the cholesterol and triglycerides from the dried egg yolk. For example, all three runs had a solvent/feed ratio of 75.

### EXAMPLE 12

Referring now to FIG. 17, a graph illustrating a comparison of different supercritical CO₂ fluid extraction efficiencies for an extractor with one column verses two columns 1700 for four dried egg products utilizing two different flow patterns and two different pressures during extraction is shown in accordance with exemplary embodiments of the present invention.

All four examples were dried with a vacuum drum dyer and extracted at a temperature of about 45° C. Extraction Run 1 was performed at a pressure of 4500 psi or about 310 bar, at a CO₂ flow rate of about 28 kg/hr, and with a flow pattern of top to bottom. Extraction Run 2 was performed at a pressure of 400 bar, at a CO₂ flow rate of about 25 kg/hr, and with a flow pattern of bottom to top. Extraction Run 3 was performed at pressure of 400 bar, at a CO₂ flow rate of about 28 kg/hr, and with a flow pattern of Top to Bottom. Extraction Run 4 was performed at pressure of 400 bar, at a CO₂ flow rate of about 25 kg/hr, in an extractor with two columns, and with a flow pattern of bottom to top. Several different measurements were taken of the four runs at set time increments. For example, the extracted oil weight, the oil extraction percentage, accumulated oil extraction percentage, and CO₂/Dried Yolk ratio were all recorded for these example as shown in the charts below:

Extraction Run 1

| | Extracted | | Accumulate | |
|---|---|---|---|---|
| Time | Oil by | Extracted | Extracted | CO₂/Dried |
| (hr) | Weight (g) | Oil (%) | Oil (%) | Yolk (kg/kg) |
| 0 | 0 | 0 | 0 | 0 |
| 1 | 47.5 | 23.8% | 23.8% | 25 |
| 2 | 20 | 10.0% | 33.8% | 50 |
| 3 | 8.5 | 4.3% | 38.0% | 75 |

Extraction Run 2

| | Extracted | | Accumulate | |
|---|---|---|---|---|
| Time | Oil by | Extracted | Extracted | CO₂/Dried |
| (hr) | Weight (g) | Oil (%) | Oil (%) | Yolk (kg/kg) |
| 0 | 0 | 0 | 0 | 0 |
| 1.2 | 359 | 23.9% | 23.9% | 20 |
| 2.4 | 148 | 9.9% | 33.8% | 40 |
| 3.6 | 50 | 3.3% | 37.1% | 60 |
| 4.8 | 26.2 | 1.7% | 38.9% | 80 |

Extraction Run 3

| | Extracted | | Accumulate | |
|---|---|---|---|---|
| Time | Oil by | Extracted | Extracted | CO₂/Dried |
| (hr) | Weight (g) | Oil (%) | Oil (%) | Yolk (kg/kg) |
| 0 | 0 | 0 | 0 | 0 |
| 0.55 | 222 | 20.2% | 20.2% | 14 |
| 1.06 | 143 | 13.0% | 33.2% | 27.0 |
| 2.16 | 41 | 3.7% | 36.9% | 55.0 |

Extraction Run 4

| | Extracted | | Accumulate | |
|---|---|---|---|---|
| Time | Oil by | Extracted | Extracted | CO₂/Dried |
| (hr) | Weight (g) | Oil (%) | Oil (%) | Yolk (kg/kg) |
| 0 | 0 | 0 | 0 | 0 |
| 1.2 | 442 | 14.7% | 14.7% | 10 |
| 2.4 | 391 | 13.0% | 27.8% | 20 |
| 3.6 | 179 | 6.0% | 33.7% | 30 |
| 4.8 | 82 | 2.7% | 36.5% | 40 |
| 6 | 77 | 5.1% | 39.0% | 50 |

The graph of FIG. 17 illustrates the increased efficiency of a two column extractor compared to an extractor with one column along with maintaining the lowest CO₂/Dried Yolk ratio. For example, the two column extractor of Extraction Run 4 had the highest Accumulated Extracted Oil percentage of 39.0%, which indicates that 90.7% of cholesterol and 92.9% of triglycerides were removed from the dried egg yolk, along with a CO₂/Dried Yolk ratio of 50. Further, unlike the other extraction runs, Extraction Run Four's Accumulated Extracted Oil continued to substantially increase as time increased unlike the Accumulated Extracted Oil of Extraction Run 2 and Extraction Run 3 that began to level off.

Extraction Run 2 and Extraction Run 3 were identical except for their flow patterns and flow rates. Extraction Run 2 had a flow pattern of bottom to top with a lower flow rate of about 25 kg/hr. Extraction Run 3 had a flow pattern of top to bottom with a higher flow rate of about 28 kg/hr. The top to bottom flow pattern of Extraction Run 3 extracted a higher percentage of cholesterol and triglycerides with a smaller Solvent/Feed ratio until the ratio exceeded 50. Moreover, as demonstrated by the charts above, Extraction Run 3 extracted the higher amount of cholesterol and triglycerides in smaller amount of time. For instance, after one hour, Extraction Run 2 had extracted 23.9% Accumulated Extracted Oil, while Extraction Run had extracted 33.2% Accumulated Extracted Oil. After two hours, but before two and half hours, Extraction Run 2 had extracted 33.8% Accumulated Extracted Oil, while Extraction Run 3 had extracted 36.9% Accumulated Extracted Oil. Therefore, it is contemplated that the top to bottom flow pattern is more efficient than the bottom to top flow pattern assuming that the difference in Accumulated Extracted Oil was not a result of the differing flow rates.

Furthermore, FIG. 17 also demonstrates the high extractor efficiency of the present invention because all three extraction runs extracted at least 84% of the cholesterol and triglycerides from the dried egg yolk while utilizing a Solvent/Feed ration of 80 or less.

In exemplary embodiments of the invention, the methods disclosed may be implemented as sets of instructions, through a single production device, and/or through multiple production devices. Further, it is understood that the specific order or hierarchy of steps in the methods disclosed are examples of exemplary approaches. Based upon design preferences, it is understood that the specific order or hierarchy of steps in the method can be rearranged while remaining within the scope and spirit of the present invention. The accompanying method claims present elements of the various steps in a sample order, and are not necessarily meant to be limited to the specific order or hierarchy presented.

It is believed that the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. An egg product including a portion of egg yolk obtained from a whole egg, comprising:
protein from the portion of egg yolk;
nutrients from the portion of egg yolk; and
phospholipids from the portion of egg yolk,
wherein the amount the phospholipids naturally found in the portion of egg yolk are retained while reducing an amount of at least one of cholesterol or triglycerides from the total amount found naturally in the portion of egg yolk by supercritical fluid extraction.

2. The egg product as claimed in claim 1, wherein the amount of the cholesterol is reduced from about 84% to about 98% of the total amount naturally found in the portion of egg yolk.

3. The egg product as claimed in claim 1, wherein the amount of the triglycerides is reduced from about 84% to about 100% of the total amount naturally found in the portion of egg yolk.

4. The egg product as claimed in claim 3, wherein the amount of the cholesterol is reduced from about 84% to about 98% of the total amount naturally found in the portion of egg yolk.

5. The egg product as claimed in claim 1, further comprising an egg white product.

6. The egg product as claimed in claim 1, wherein the protein has a protein structure which is not substantially denatured.

7. A food product made from an egg product, the egg product comprising a portion of egg yolk obtained from a whole egg, the egg containing food product comprising:
protein from the portion of egg yolk;
nutrients from the portion of egg yolk; and
phospholipids from the portion of egg yolk,
wherein an amount of the phospholipids naturally found in the portion of the egg yolk are retained while reducing an amount of at least one of cholesterol or triglycerides from the total amount naturally found in the portion of the egg yolk by supercritical fluid extraction.

8. The food product as claimed in claim 7, wherein the amount of the cholesterol is reduced from about 84% to about 98% of the total amount naturally found in the portion of egg yolk.

9. The food product as claimed in claim 8, wherein the amount of the triglycerides is reduced from about 84% to about 100% of the total amount naturally found in the portion of egg yolk.

10. The food product as claimed in claim 9, wherein the amount of the cholesterol is reduced from about 84% to about 98% of the total amount naturally found in the portion of egg yolk.

11. The food product as claimed in claim 7, further comprising an egg white product.

12. The food product as claimed in claim 7, wherein the protein has a protein structure which is not substantially denatured.

13. A system for producing an egg product comprising a portion of egg yolk obtained from a whole egg, the egg product comprising protein from the portion of egg yolk; nutrients from the portion of egg yolk; and phospholipids from the portion of egg yolk, wherein an amount of the phospholipids naturally found in the portion of the egg yolk is retained while reducing an amount of at least one of cholesterol or triglycerides from the total amount naturally found in the portion of the egg yolk, the system comprising:
a separator for substantially separating the portion of egg yolk from the whole egg;
a dryer for drying the separated portion of the egg yolk; and
an extractor for selectively extracting the amount of at least one of the cholesterol or the triglycerides from the separated portion of egg yolk,
wherein the extractor utilizes a supercritical fluid for extracting the amount of at least one of the cholesterol or the triglycerides.

14. The system as claimed in claim 14, wherein the amount of the cholesterol is reduced from about 84% to about 98% of the total amount naturally found in the portion of egg yolk.

15. The system as claimed in claim 14, wherein the amount of the triglycerides is reduced from about 84% to about 100% of the total amount naturally found in the portion of egg yolk.

16. The system as claimed in claim 15, wherein the amount of the cholesterol is reduced from about 84% to about 98% of the total amount naturally found in the portion of egg yolk.

17. The system as claimed in claim 13, wherein the dryer is a vacuum belt dryer.

18. The system as claimed in claim 17, wherein the vacuum pressure is set at about 2 mbar to about 10 mbar.

19. The system as claimed in claim 17, wherein the vacuum belt drying rate about 0.5 kg/hr/m² to about 1.4 kg/hr/m².

20. The system as claimed in claim 17, wherein the vacuum belt dryer utilizes a gradient temperature along the length of a belt from about 90° C. to about 15° C. selected from a group consisting of four different temperature zones and five different temperature zones.

21. The system as claimed in claim 20, wherein a temperature zone has a temperature from about 80° C. to about 90° C.

22. The system as claimed in claim 20, wherein a temperature zone has a temperature of about 70° C. to about 85° C.

23. The system as claimed in claim 20, wherein a temperature zone has a temperature from about 60° C. to about 80° C.

24. The system as claimed in claim 20, wherein a temperature zone has a temperature from about 20° C. to about 60° C.

25. The system as claimed in claim 20, wherein a temperature zone has a temperature from about 15° C. to about 35° C.

26. The system as claimed in claim 17, wherein the vacuum belt dryer comprises a nozzle for placing the liquid egg onto a belt of the vacuum belt dryer.

27. The system as claimed in claim 26, wherein the nozzle oscillates.

28. The system as claimed in claim 26, wherein the nozzle has a temperature from about 20° C. to about 50° C.

29. The system as claimed in claim 26, wherein the nozzle feeds the egg yolk across the belt of the vacuum belt dryer in a thin, substantially even layer at about 3 mm to about 7 mm thick.

30. The system as claimed in claim 13, wherein the dryer comprises a spray dryer.

31. The system as claimed in claim 30, wherein the spray dryer utilizes a heating medium heated from about 375° F. to about 425° F. to dry the separated portion of egg yolk.

32. The system as claimed in claim 30, wherein the spray dryer recirculates the heating medium to dry the separated portion of egg yolk.

33. The system as claimed in claim 31, wherein the spray dryer produces dried egg yolk particles with a diameter from about 30 microns to about 200 microns and with a bulk density of about 0.45 g/ml to about 0.55 g/ml.

34. The system as claimed in claim 31, wherein N₂ is added to the separated portion of egg yolk before being dried by the spray dryer.

35. The system as claimed in claim 34, wherein the spray dryer produces dried egg yolk particles with a diameter from about 30 microns to about 2200 microns and with a bulk density of about 0.15 g/ml to about 0.40 g/ml.

36. The system as claimed in claim 34, wherein the spray dryer sprays the portion of egg yolk at about 90 psi to about 110 psi into a gravity fall chamber of the spray dryer.

37. The system as claimed in claim 34, wherein the spray dryer produces dried egg yolk particles with a bulk density from about 0.15 g/ml to about 0.55 g/ml.

38. The system as claimed in claim 13, wherein the extractor is utilized at a temperature from about 45° C. to about 75° C. and at a pressure from about 300 bar to about 500 bar.

39. The system as claimed in claim 13, wherein the extractor is utilized at a temperature from about 65° C. at a pressure from about 500 bar.

40. The system as claimed in claim 13, wherein the extractor is utilized at a temperature from about 45° C. at a pressure from about 400 bar.

41. The system as claimed in claim 13, wherein the extractor is utilized at a temperature from about 60° C. at a pressure from about 310 bar.

42. The system as claimed in claim 13, wherein the supercritical fluid is recycled and reutilized in the extractor.

43. The system as claimed in claim 13, wherein the supercritical fluid is CO₂.

44. The system as claimed in claim 13, wherein the extractor further comprises a reducer and a supercritical recycler.

45. The system as claimed in claim 13 further comprising a pasteurizer, a chiller, and an aseptic packager.

46. The system as claimed in claim 13 further comprising, a reconstitutor for reconstituting the dried portion of egg yolk.

47. The system as claimed in claim 46, wherein the reconstitutor comprises at least one of ultra high shear mixing, temperature control, and a vacuum pump.

48. The system as claimed in claim 46, wherein the reconstitutor further comprises a recycler and a mixer.

49. The system as claimed in claim 46, further comprising a pasteurizer, wherein the pasteurizer pasteurizes at least one of reduced egg yolk or reduced egg product comprising an egg white product.

50. A method of producing a dried egg yolk with an average diameter from about 30 microns to about 2200 microns, comprising:
blending an antioxidant with a liquid egg yolk;
pasteurizing the liquid egg yolk with heat;
adding at least one of an N₂ gas or a CO₂ gas to the liquid egg yolk; and
spraying the heated liquid egg yolk through a heating medium in a spray dryer to form the dried egg yolk with the average diameter of about 30 microns to about 2200 microns.

51. The method as claimed in claim 50, wherein the antioxidant is at least one of vitamin C, vitamin E, or rosemary.

52. The method as claimed in claim 50, wherein the liquid egg yolk is pasteurized at 147° F. from about 2.5 minutes to about 5.5 minutes.

53. The method as claimed in claim 50, wherein the liquid egg yolk is sprayed at about 90 psi to about 110 psi into a gravity fall chamber of the spray dryer.

54. The method as claimed in claim 50, wherein the heated medium has a temperature from about 375° F. to about 425° F.

55. The method as claimed in claim 50, wherein the heated liquid egg yolk will fall through a gravity chamber of the spray dryer for about 15 feet to about 25 feet.

56. The method as claimed in claim 50, wherein the dried egg yolk has a bulk density from about 0.15 g/ml to about 0.55 g/ml.

57. The method as claimed in claim 50, wherein the dried egg yolk allows for an extractor utilizing about 80 pounds or less of supercritical fluid for every one pound of dried egg yolk to extract at least 84% of at least one of the cholesterol and the triglycerides.

58. The method as claimed in claim 50, wherein the dried egg yolk allows for an extractor utilizing about 60 pounds or less of supercritical fluid for every one pound of dried egg yolk to extract at least 84% of at least one of the cholesterol and the triglycerides.

59. A method of producing dried egg yolk with a honeycomb type structure, comprising:
blending an antioxidant with a liquid egg yolk;
distributing the liquid egg yolk onto a belt of a vacuum belt dryer; and
drying the distributed liquid egg yolk with a temperature gradient across the length of the belt of the vacuum belt dryer to form the dried egg yolk with the honeycomb type structure.

60. The method as claimed in claim 59 further comprising, pasteurizing the blended antioxidant and liquid egg yolk with heat.

61. The method as claimed in claim 59, wherein the antioxidant is at least one of vitamin C, vitamin E, or rosemary.

62. The method as claimed in claim 59, wherein the gradient temperature is from about 20° C. to about 90° C. selected from a group consisting of four different temperature zones and five different temperature zones.

63. The method as claimed in claim 62, wherein a temperature zone has a temperature from about 80° C. to about 90° C.

64. The method as claimed in claim 62, wherein a temperature zone has a temperature from about 70° C. to about 85° C.

65. The method as claimed in claim 62, wherein a temperature zone has a temperature from about 60° C. to about 80° C.

66. The method as claimed in claim 62, wherein a temperature zone has a temperature from about 20° C. to about 60° C.

67. The method as claimed in claim 62, wherein a temperature zone has a temperature from about 15° C. to about 35° C.

68. The method as claimed in claim 59, wherein the vacuum belt dryer comprises a nozzle to feed the liquid egg yolk on to the belt.

69. The method as claimed in claim 68, wherein the nozzle oscillates while distributing the liquid egg yolk onto the belt.

70. The method as claimed in claim 68, wherein the nozzle has a temperature from about 20° C. to about 63° C.

71. The method as claimed in claim 68, wherein the nozzle feeds the egg yolk across the belt of the vacuum belt dryer in a thin, substantially even layer at about 3 mm to about 7 mm thick.

72. The method as claimed in claim 59, wherein the dried egg yolk allows an extractor to utilize about 80 pounds or less of supercritical fluid for every one pound of dried egg yolk to extract at least 84% of at least one of the cholesterol and the triglycerides.

73. The method as claimed in claim 59, wherein the dried egg yolk allows an extractor to utilize about 60 pounds or less of supercritical fluid for every one pound of dried egg yolk to extract at least 84% of at least one of the cholesterol and the triglycerides.

74. A method of reconstituting dried egg yolk, comprising:
adding a liquid to the dried egg yolk;
mixing the liquid and the dried egg yolk with ultra high shear; and
mixing the liquid and the dried egg yolk in a temperature controlled vacuum chamber to produce the reconstituted egg yolk.

75. The method as claimed in claim 74 wherein, the liquid is at least one of water or an egg white product.

76. The method as claimed in claim 74 wherein, the vacuum chamber has a gauge pressure from about 25 inches of Hg vacuum to about 30 inches of Hg vacuum.

77. The method as claimed in claim 74 wherein, the vacuum chamber maintains a temperature from about 33° F. to about 40° F.

78. A method for producing an egg product, the egg product comprising a portion of egg yolk obtained from whole egg, the method comprising:
separating an egg shell, an egg white, and an egg yolk from the whole egg;
pasteurizing the separated egg yolk;
drying the pasteurized egg yolk; and
reducing the dried egg yolk with a supercritical fluid by extracting at least one of cholesterol or triglycerides while selectively not extracting phospholipids.

79. The method as claimed in claim 78 further comprising, reconstituting the reduced egg yolk.

80. The method as claimed in claim 78 further comprising, pasteurizing the separated egg yolk.

81. The method as claimed in claim 78 further comprising, adding N₂ gas or CO₂ gas to the separated egg yolk before drying the separated egg yolk.

82. The method as claimed in claim 78 further comprising, adding a processing aid to the separated egg yolk before drying the separated egg yolk.

83. The method as claimed in claim 78 further comprising, mixing the reduced egg yolk with an egg white product.

84. The method as claimed in claim 83, further comprising pasteurizing the mixed reduced egg yolk with an egg white product.

85. The method as claimed in claim 78, wherein from about 84% to about 98% of a total amount of the cholesterol naturally found in the egg yolk is extracted by the supercritical fluid.

86. The method as claimed in claim 78, wherein from about 84% to about 100% of a total amount of the triglycerides naturally found in the egg yolk is extracted by the supercritical fluid.

87. The method as claimed in claim 86, wherein from about 84% to about 98% of a total amount of the cholesterol naturally found in the egg yolk is extracted by the supercritical fluid.

88. The method as claimed in claim 78 further comprising, adding an antioxidant to the separated egg yolk.

89. The method as claimed in claim 88 wherein, the antioxidants are at least one of vitamin E, vitamin C, or rosemary.

90. The method as claimed in claim 89, wherein from about 200 ppm to about 630 ppm of vitamin E is added to the separated egg yolk.

91. The method as claimed in claim 89, wherein from about 180 ppm to about 350 ppm of vitamin C is added to the separated egg yolk.

92. The method as claimed in claim 78, wherein the supercritical fluid is CO₂.

93. The method as claimed in claim 78, wherein the extractor reducing the dried egg yolk is utilized at a temperature of about 45° C. to about 65° C. and at a pressure of about 300 bar to about 500 bar.

94. The method as claimed in claim 78, wherein the dried egg yolk allows an extractor to utilize about 80 pounds or less of supercritical fluid for every one pound of the dried egg yolk in the extractor to extract at least 84% of at least one of the cholesterol or the triglycerides.

95. The method as claimed in claim 78, wherein the dried egg yolk allows an extractor to utilize about 60 pounds or less of supercritical fluid for every one pound of the dried egg yolk in the extractor to extract at least 84% of at least one of the cholesterol or the triglycerides.

96. A method for producing a food product made from an egg product, the egg product comprising a portion of egg yolk obtained from whole egg, the method comprising:
separating an egg shell, an egg white, and an egg yolk from the whole egg;
pasteurizing a separated egg yolk;
drying the pasteurized egg yolk;
reducing the dried egg yolk with a supercritical fluid to extract at least one of cholesterol or triglycerides white selectively not extracting phospholipids; and
utilizing the reduced egg yolk in an egg containing food product.

97. The method as claimed in claim 96 further comprising, reconstituting the reduced egg yolk.

98. The method as claimed in claim 96 further comprising, pasteurizing the separated egg yolk.

99. The method as claimed in claim 96 further comprising, adding at least one of N₂ gas or CO₂ gas to the separated egg yolk before drying the separated egg yolk.

100. The method as claimed in claim 96 further comprising, adding a processing aid to the separated egg yolk before drying the separated egg yolk.

101. The method as claimed in claim 96 further comprising, mixing the reduced egg yolk with an egg white product.

102. The method as claimed in claim 101, further comprising pasteurizing the mixed reduced egg yolk with egg white product.

103. The method as claimed in claim 96, wherein from about 84% to about 98% of a total amount of the cholesterol naturally found in the egg yolk is extracted by the supercritical fluid.

104. The method as claimed in claim 96, wherein from about 84% to about 100% of a total amount of the triglycerides naturally found in the egg yolk is extracted by the supercritical fluid.

105. The method as claimed in claim 104, wherein from about 84% to about 98% of a total amount of the cholesterol naturally found in the egg yolk is extracted by the supercritical fluid.

106. The method as claimed in claim 96 further comprising, adding an antioxidant to the separated egg yolk.

107. The method as claimed in claim 106 wherein, the antioxidants are at least one of vitamin E, vitamin C, or rosemary.

108. The method as claimed in claim 107, wherein about 200 ppm to about 630 ppm of the vitamin E is added to the separated egg yolk.

109. The method as claimed in claim 107, wherein about 180 ppm to about 350 ppm of the vitamin C is added to the separated egg yolk.

110. The method as claimed in claim 96 wherein, the supercritical fluid is CO₂.

111. The method as claimed in claim 96, wherein the extractor reducing the dried egg yolk is utilized at a temperature of about 45° C. to about 65° C. and at a pressure of about 300 bar to about 500 bar.

112. The method as claimed in claim 96, wherein the dried egg yolk allows an extractor to utilize about 80 pounds or less of supercritical fluid for every one pound of the dried egg yolk in the extractor to extract at least 84% of at least one of the cholesterol or the triglycerides.

113. The method as claimed in claim 96, wherein the dried egg yolk allows an extractor to utilize about 60 pounds or less of supercritical fluid for every one pound of the dried egg yolk in the extractor to extract at least 84% of at least one of the cholesterol or the triglycerides.

114. The method as claimed in claim 96, wherein the egg containing food product is selected from a group consisting of fried eggs, omelets, mayonnaise, egg nog, liquid egg products, ice cream, baked goods, custards, souffles, meringue, angel food cake, sponge cakes, and aerosol-based creams.
